(19) United States
(12) Patent Application Publication
(10) Pub. No.: US 2026/0003874 A1
(43) Pub. Date: Jan. 1, 2026

(54) GENERATING RESPONSES TO QUERIES USING ENTITY-SPECIFIC GENERATIVE ARTIFICIAL INTELLIGENCE AGENTS

(71) Applicant: Microsoft Technology Licensing, LLC, Redmond, WA (US)

(72) Inventors: Achyuthan Jootoo Ramesh Bapu, San Jose, CA (US); Shilpi Agrawal, San Francisco, CA (US); Michaela C. Jillings, Seattle, WA (US); Christopher Wright Lloyd, II, Brooklyn, NY (US); Jeremy Keane Owen, Mountain View, CA (US); Yunxiang Ren, Goleta, CA (US); Ko-Cheng Wang, Santa Clara, CA (US); Xinyu Wang, Santa Clara, CA (US); Haichao Wei, Santa Clara, CA (US)

(21) Appl. No.: 18/759,036

(22) Filed: Jun. 28, 2024

(51) Int. Cl. G06F 16/245; G06N 5/022

(52) U.S. Cl. CPC G06F 16/24569; G06N 5/022

(57) ABSTRACT

Techniques for generating AI-powered responses tailored to a specific entity's communication style. The techniques involve selecting a particular AI agent associated with an entity, receiving a user query, and generating an embedding from it. This embedding is used to retrieve relevant content from the entity's knowledge database. The entity's communication type is then determined. A large language model (LLM) prompt is created, combining the retrieved content and instructions to apply the entity's communication style. This prompt is submitted to an LLM service, which generates an output. A response based on this output is returned to the user. The techniques enable the creation of AI-generated responses that are both informative and aligned with the entity's preferred communication style, enhancing the consistency and effectiveness of AI-powered customer interactions or information dissemination for the entity.

### BACKGROUND

Generative artificial intelligence (AI) agents are computer systems designed to create new content based on patterns learned from existing data. These agents can produce various types of output, including text, images, and audio. They operate by processing input data and generating novel content that is coherent and relevant to the given context. Generative AI has applications in numerous fields, including creative writing, content creation, and automated assistance.

In the realm of natural language processing, generative AI agents can produce human-like text based on given prompts or inputs. These systems have been trained on vast amounts of textual data, allowing them to understand and mimic patterns of human language. Such agents can be used for tasks like drafting emails, creating marketing copy, or assisting with creative writing projects. The quality and relevance of the generated text can vary depending on the specific implementation and training of the AI system.

### BRIEF DESCRIPTION OF THE DRAWINGS

The following detailed description of certain embodiments of the invention are understood by reference to the following figures:

FIG. 1 illustrates an example multi-user application system environment in which techniques for generating responses to queries using entity-specific generative artificial intelligence agents are implemented, according to some embodiments of the present disclosure.

FIG. 2 illustrates example ways in which a selection of a particular generative artificial intelligence (AI) agent can be made by a multi-user application system, according to some embodiments of the present disclosure.

FIG. 3 illustrates a way in which the selection of a particular generative artificial intelligence (AI) agent can be made by a user of a client device, according to some embodiments of the present disclosure.

FIG. 4 illustrates a first example method for generating an embedding based on a query, according to some embodiments of the present disclosure.

FIG. 5 illustrates a second example method for generating the embedding based on a query, according to some embodiments of the present disclosure.

FIG. 6 illustrates components of a large language model (LLM) prompt, according to some embodiments of the present disclosure.

FIG. 7 illustrates a method for reformulating a query to be on-topic for a particular generative artificial intelligence (AI) agent, according to some embodiments of the present disclosure.

FIG. 8 illustrates an example Transformer model architecture that may be used in an implementation of a Large Language Model (LLM), according to some embodiments of the present disclosure.

FIG. 9 illustrates an example multi-user application system in which the techniques disclosed herein for generating responses to queries using entity-specific generative artificial intelligence agents are implemented, according to some embodiments of this disclosure.

FIG. 10 illustrates an example of a programmable electronic device that processes and manipulates data to perform the techniques disclosed herein for generating responses to queries using entity-specific generative artificial intelligence agents, according to some embodiments of this disclosure.

### DETAILED DESCRIPTION

Systems, methods, and non-transitory computer-readable media (collectively referred to herein as “techniques”) are disclosed for generating responses to queries using entity-specific generative artificial intelligence agents.

According to some embodiments, the techniques encompass a computer-implemented method that begins by receiving a selection of a generative artificial intelligence (AI) agent from a set of one or more agents, where the selected agent is associated with an entity. The method then receives a query sent by a client device. An embedding is generated based on the query, which is used to retrieve content from a knowledge database that stores information related to the associated entity. The retrieved content is considered relevant to the query. The method also determines a communication type associated with the entity. A large language model (LLM) prompt is then constructed, which includes the query-relevant content retrieved from the knowledge database and instructions for the LLM to apply the determined communication type to its output. The LLM prompt is submitted to an LLM service, which generates a particular output. The method returns a response to the query based on the LLM's output.

The method utilizes embeddings, which are vector representations of the query, to facilitate efficient retrieval of relevant content from the knowledge database. The LLM, a deep learning model trained on vast amounts of text data, is employed to generate human-like responses based on the provided prompt. The prompt incorporates both the retrieved query-relevant content and instructions for applying a specific communication type, which is associated with the entity. This allows the LLM to generate responses that are not only informative but also tailored to the entity's communication style. The LLM service is a separate component that receives the prompt and returns the generated output, which is then used to formulate the response to the user's query.

The method improves the operation of a computer system by optimizing the process of generating responses to user queries. The use of embeddings to retrieve query-relevant content from a knowledge database reduces the computational overhead associated with searching through large amounts of data. Embeddings provide a compact representation of the query's semantic information, enabling efficient similarity-based retrieval. This approach minimizes the time and resources required to identify the most pertinent content for generating a response.

Furthermore, the method's utilization of a large language model (LLM) enhances the system's ability to generate coherent and contextually appropriate responses. LLMs are pre-trained on vast corpora of text data, allowing them to capture complex linguistic patterns and generate human-like text. By incorporating query-relevant content and communication type instructions into the LLM prompt, the method ensures that the generated responses are not only informative but also aligned with the associated entity's communication style. This targeted approach reduces the need for additional post-processing or filtering of the LLM's output, thereby improving the system's efficiency.

The separation of concerns between the main computer system and the LLM service also contributes to improved performance. By offloading the computationally intensive task of text generation to a dedicated LLM service, the main system can focus on other essential tasks, such as handling user interactions and managing the knowledge database. This distributed architecture allows for better resource allocation and parallel processing, leading to faster response times and increased overall system throughput.

Moreover, the method's ability to select a specific generative AI agent from a set of agents based on the associated entity further optimizes the response generation process. Each AI agent can be tailored to handle queries related to a particular entity or domain, leveraging specialized knowledge and communication styles. This targeted approach reduces the computational overhead associated with processing irrelevant or out-of-domain queries, resulting in more efficient use of system resources.

As an example, the method may be applied to an executive coach and advisor entity specializing in leadership and organizational culture. A user, Sarah, submits a query asking for key strategies to become an effective leader in her organization.

The method begins by generating an embedding of Sarah's query using techniques such as word embeddings or sentence transformers. The embedding captures the semantic meaning and context of the query in a dense vector representation. This embedding is then used to retrieve relevant content from the knowledge database associated with the executive coach and advisor entity. The knowledge database contains information related to leadership strategies, organizational culture, and other relevant topics.

The retrieval process involves comparing the query embedding with the embeddings of the content stored in the knowledge database using similarity metrics such as cosine similarity or Euclidean distance. The most relevant content is selected based on the highest similarity scores. In this case, the retrieved content may include information about effective communication, delegation, goal setting, and fostering a positive work environment.

Next, the method determines the communication type associated with the executive coach and advisor entity. This communication type could encompass characteristics such as a motivational tone, actionable advice, and a focus on personal development. The retrieved query-relevant content and the instructions to apply the communication type are then combined to form the LLM prompt.

The LLM prompt is submitted to the LLM service, which generates a response based on the provided context and instructions. The LLM, having been trained on a vast corpus of text data, can generate coherent and contextually appropriate responses that align with the specified communication type. In this example, the LLM may generate a response that includes specific strategies for effective leadership, such as setting clear expectations, actively listening to team members, recognizing achievements, and fostering a culture of continuous learning.

The method returns the generated response to Sarah, providing her with valuable insights and guidance on becoming an effective leader within her organization. The response is tailored to the executive coach and advisor's communication style, ensuring that the advice is presented in a motivational and actionable manner.

By leveraging embeddings for efficient content retrieval, utilizing the LLM's generative capabilities, and incorporating the entity-specific communication type, the method optimizes the process of generating a relevant and helpful response to Sarah's query. This approach improves the computer system's performance by reducing computational overhead, generating contextually appropriate responses, and providing targeted advice based on the user's specific needs.

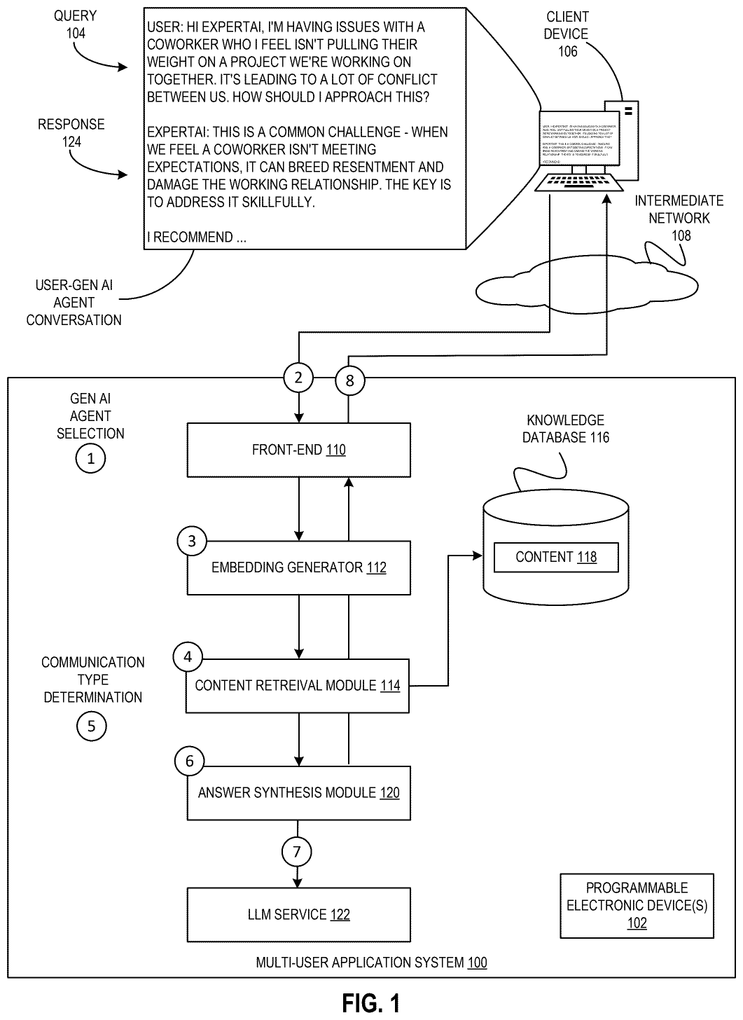

Turning now to the drawings, FIG. 1 illustrates an example multi-user application system environment in which techniques for generating responses to queries using entity-specific generative artificial intelligence agents are implemented, according to some embodiments of the present disclosure.

FIG. 1 depicts a method by numbered circles which in some instances overlay directed arrows. The direction of an arrow represents a direction of data flow between the components connected by the arrow but necessarily the exclusive direction.

The computer-implemented method takes place within a multi-user application environment, which encompasses a client device (106), an intermediate network (108), and a multi-user application system (100). The multi-user application system (100) is implemented using one or more programmable electronic devices (102).

The method begins with the multi-user application system (100) receiving a selection of a generative AI agent from a set of one or more agents. The selected AI agent is associated with an entity. Next, the front-end (110) of the multi-user application system (100) receives a query (104) sent by the client device (106) via the intermediate network (108).

An embedding generator (112) within the multi-user application system (100) generates an embedding based on the received query (104). The generated embedding is then used by a content retrieval module (114) to retrieve query-relevant content associated with the entity from a knowledge database (116), which stores content (118) related to the entity.

The multi-user application system (100) determines a communication type associated with the entity. An answer synthesis module (120) within the system generates a large language model (LLM) prompt, which includes the retrieved query-relevant content and instructions for applying the determined communication type to the LLM output.

The answer synthesis module (120) submits the LLM prompt to an LLM service (122) and receives a particular LLM output in response. The LLM service (122) applies the specified communication type to its output, as instructed in the prompt.

The front-end (110) of the multi-user application system (100) returns a response (124) to the query (104) based on the particular LLM output received from the LLM service (122). The response (124) reflects the application of the entity-specific communication type.

Throughout the process, the multi-user application system (100) and its components, including the embedding generator (110), content retrieval module (114), and answer synthesis module (120), work together to handle the query (104), retrieve relevant content, generate an appropriate LLM prompt, and synthesize a response (124) based on the LLM output and the specified communication type. The interaction between the client device (106) and the multi-user application system (100) occurs via the intermediate network (108), enabling communication within the multi-user application environment.

Take an example where the multi-user application system (100) has received a selection of the generative AI agent named “ExpertAI,” which is associated with an executive coach and advisor entity specializing in leadership and organizational culture.

The front-end (110) of the multi-user application system (100) receives a query (104) from the client device (106) via the intermediate network (108). The query states, “Hi EXPERTAI, I'm having issues with a coworker who I feel isn't pulling their weight on a project we're working on together. It's leading to a lot of conflict between us. How should I approach this?”

The embedding generator (112) processes the query (104) and generates an embedding that captures its semantic meaning. The content retrieval module (114) uses this embedding to search the knowledge database (116) and retrieve content (118) relevant to the query (104). The retrieved content may include information about conflict resolution, communication strategies, and managing expectations in the workplace.

In an embodiment, the content retrieval module (114) is designed to interface with the knowledge database (116) in a manner that respects the specificity of the chosen expert agent. When a particular generative AI agent is selected from the set of available agents, the content retrieval process may be constrained to focus on the corpus of information associated with that agent's corresponding entity or author.

This agent-specific retrieval mechanism may ensure that the content (118) extracted from the knowledge database (116) is not only relevant to the query (104) but also accurately represents the viewpoints, expertise, and communication style of the selected agent. By limiting the retrieval scope to agent-specific content, the system may mitigate the risk of hallucinating information or providing responses that deviate from the agent's established knowledge base.

The embedding generated by the embedding generator (112) may be utilized within this constrained search space, allowing for semantic matching between the query and the agent-specific content. This approach may maintain the integrity of the agent's persona and ensures that the subsequent LLM prompt generation and output are grounded in verified, entity-associated information, thereby enhancing the accuracy and authenticity of the system's responses.

The multi-user application system (100) determines the communication type associated with the executive coach and advisor entity. This communication type may involve a supportive tone, practical advice, and a focus on maintaining professional relationships.

The answer synthesis module (120) constructs an LLM prompt by combining the retrieved query-relevant content and instructions for applying the determined communication type. The prompt is then submitted to the LLM service (122) for processing.

The LLM service (122) generates a response (124) based on the prompt, incorporating the specified communication type. For example, the LLM output might begin with, “This is a common challenge-when we feel a coworker isn't meeting expectations, it can breed resentment and damage the working relationship. The key is to address it skillfully.”

The front-end (110) receives the LLM output and returns it as the response (124) to the query (104). The response (124) continues to provide guidance on how to approach the situation with the coworker, maintaining a supportive and professional tone in line with the entity's communication style.

In an embodiment, the techniques implement a conversational continuation mechanism that enables follow-up interactions. After returning the initial response (124) to the query (104), the front-end (110) may maintain an active session state for the client device. This session state may encapsulate relevant context from the previous interaction, including the original query, the generated embedding, the retrieved content, and the LLM output.

Upon receiving a follow-up query from the client device, the techniques may leverage the stored session state to enhance its understanding of the ongoing conversation. The embedding generator (112) may create a new embedding that incorporates both the follow-up query and the contextual information from the previous interaction. This compound embedding may then be used by the content retrieval module (114) to fetch additional query-relevant content that maintains continuity with the previous response while addressing the new aspects introduced by the follow-up query.

The LLM prompt generator may integrate this historical context and newly retrieved content into the prompt structure, instructing the LLM to produce a response that not only answers the follow-up query but also maintains coherence with the ongoing conversation. This process can be repeated for multiple rounds of interaction, with each iteration building upon the accumulated context to provide increasingly nuanced and relevant responses while adhering to the entity's communication style and knowledge base.

Throughout this process, the multi-user application system (100) and its components collaborate to generate a contextually appropriate response. The embedding generator (112) and content retrieval module (114) work together to identify relevant information from the knowledge database (116). The answer synthesis module (120) integrates the retrieved content and communication type instructions into an LLM prompt. The LLM service (122) processes the prompt and generates an output that reflects the entity's communication style. The front-end (110) delivers the response (124) to the client device (106) via the intermediate network (108).

In an embodiment, the multi-user application system (100) employs a Retrieval-Augmented Generation (RAG) approach, which offers technical advantages. By leveraging the embedding generator (112) and content retrieval module (114) to identify and fetch query-relevant content from the knowledge database (116), the techniques may substantially reduce the need for large context windows in the underlying Large Language Model (LLM). This reduction in context window size leads to improved computational efficiency and decreased memory requirements during the LLM inference process.

In an embodiment, the RAG methodology implemented according to the techniques enables a more efficient and targeted retrieval of relevant information based on the query. The embedding-based search may allow for semantic matching between the query and the stored content, surpassing simple keyword matching. This semantic search capability may enhance the system 100's ability to identify and extract pertinent information, even when the query and stored content use different but semantically related terms. Consequently, the techniques can provide more accurate and contextually appropriate responses while minimizing the amount of irrelevant information processed by the LLM.

Furthermore, the integration of retrieved, entity-specific content into the LLM prompt may reduce the likelihood of hallucination in the LLM's output. By grounding the LLM's generation process in factual, pre-vetted information associated with the entity, the techniques may constrain the LLM's propensity to generate false or unsupported information. This may enhance the reliability and trustworthiness of the responses, ensuring that the output aligns closely with the entity's knowledge base and communication style. The combination of efficient retrieval, reduced context windows, and hallucination mitigation provided by some embodiments of the techniques results in a more robust, accurate, and computationally efficient AI agent system.

The multi-user application system (100) encompasses a computing system that facilitates interaction between users and generative AI agents. It is implemented using one or more programmable electronic devices (102), which provide the computational resources used for its operation.

The system (100) encompasses several components that work together to process user queries and generate responses. The front-end (110) serves as the interface between the users and the system, receiving queries from client devices (106) via an intermediate network (108). The front-end (110) is responsible for handling the communication protocol and ensuring the queries are properly formatted for further processing.

Once a query is received, the embedding generator (112) processes the query and creates an embedding, which is a dense vector representation that captures the semantic meaning of the query. This embedding is then used by the content retrieval module (114) to search for relevant content within the knowledge database (116). The knowledge database (116) stores content (118) associated with the entity that the selected AI agent represents.

The multi-user application system (100) also includes a component that determines the communication type associated with the entity. This communication type defines the style and tone of the responses generated by the AI agent.

The answer synthesis module (120) generates the response. It constructs a large language model (LLM) prompt by combining the query-relevant content retrieved from the knowledge database (116) and instructions for applying the determined communication type. This prompt is then sent to an LLM service (122) for processing.

While the LLM service (122) is a component of the multi-user application system (100) such as in the example of FIG. 1, the techniques are designed to accommodate flexible deployment of the Large Language Model (LLM) service (122), allowing for both external and internal implementations. An external LLM service may encompass a remotely hosted model accessible via API calls. An external LLM service may be offered by a cloud service provider or specialized AI company. This configuration leverages the provider's infrastructure and computational resources, enabling access to state-of-the-art models without the need for local high-performance hardware.

Conversely, an internal LLM service may encompass a model deployed within the organization's own infrastructure, either on-premises or in a private cloud environment. This setup offers greater control over data privacy, latency, and customization. The techniques also support on-device LLM services, where a compact version of the language model is deployed directly on the client device. On-device deployment is particularly beneficial for scenarios requiring low-latency responses, offline functionality, or enhanced data privacy.

The answer synthesis module (120) may be designed to interface with various LLM service configurations. It may employ a standardized communication protocol that abstracts the underlying LLM implementation details. This abstraction layer may allow the system to switch between external, internal, and on-device LLM services without modifying the core logic of the answer synthesis module (120). The choice of LLM service deployment can be dynamically determined based on factors such as query complexity, response time requirements, available computational resources, and data sensitivity considerations. This flexibility may ensure that the techniques can adapt to diverse operational environments and user needs while maintaining consistent functionality across different LLM service implementations.

The LLM service (122) generates a response based on the provided prompt, incorporating the specified communication type. The generated output is returned to the answer synthesis module (120), which then sends it back to the front-end (110).

The front-end (110) returns the response (124) to the client device (106) that originally sent the query (104). The response (124) is based on the output generated by the LLM service (122) and reflects the application of the entity-specific communication type.

Throughout this process, the multi-user application system (100) coordinates the interaction between users, AI agents, and the various components involved in processing queries and generating responses. The system's architecture allows for scalability and flexibility, enabling it to handle multiple users and AI agents simultaneously.

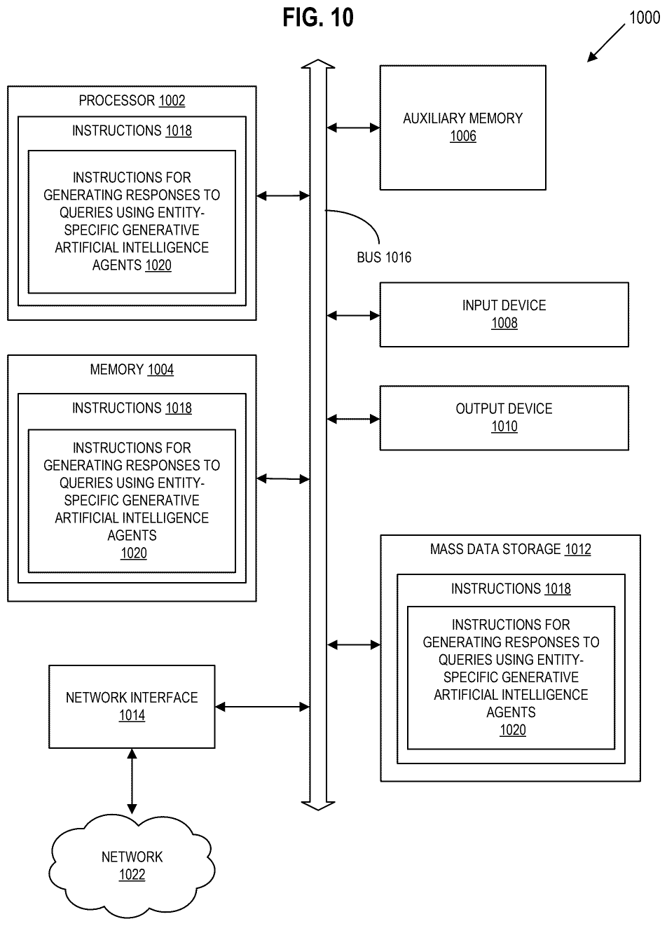

One or more programmable electronic devices (102) serves as the hardware foundation for the multi-user application system (100). The one or more programmable electronic devices (102) encompass one or more computing units that provide the necessary computational resources and infrastructure to execute the various components and processes of the system (100). An example of a suitable programmable electronic device is described below with respect to FIG. 10.

The query (104) represents an input or request sent by a client device (106) to the multi-user application system (100). It is the mechanism through which users interact with the system and seek information or assistance from the generative AI agents associated with specific entities.

In an embodiment, the query (104) is transmitted from the client device (106) to the front-end (110) of the multi-user application system (100) via an intermediate network (108). This network facilitates the communication between the client device and the system, enabling the exchange of data packets containing the query information.

In an embodiment, the multi-user application system (100) is designed with a modular architecture that supports distributed processing across various computational environments. This flexibility allows for the query processing, knowledge retrieval, and response generation to be executed in any combination of on-device and cloud-based configurations. For example, the system may employ a service-oriented architecture (SOA) with well-defined interfaces between components, enabling seamless integration regardless of the deployment location.

For on-device processing, the client device (106) can host lightweight versions of key components such as the embedding generator (112), content retrieval module (114), and a compact LLM. This configuration may utilize edge computing principles to minimize latency and enhance data privacy. The knowledge database (116) may be synchronized with a subset of entity-specific content relevant to the user's context. In cases where the client device has limited computational resources, these components can dynamically offload processing to cloud services as needed.

Conversely, in a cloud-centric deployment, the bulk of the processing may occur on remote servers related to the client device (106). The query (104) may be transmitted via the intermediate network (108) to cloud-based instances of the system components. This configuration may allow for more complex models and larger knowledge bases to be utilized. A hybrid approach may also be supported, where certain components (e.g., the embedding generator (112)) run on-device while others (e.g., the LLM service (122)) operate in the cloud. The techniques may dynamically determine the optimal processing location based on factors such as query complexity, network conditions, and device capabilities, ensuring efficient and responsive operation across diverse usage scenarios.

The structure and content of the query (104) may vary depending on the specific implementation of the multi-user application system (100) and the requirements of the generative AI agents. However, in general, the query (104) includes a combination of text, keywords, or other relevant data that express the user's intent or the information they seek.

For example, if the multi-user application system (100) is designed to provide customer support, the query (104) may contain a description of the user's problem, along with any relevant details or context. If the system is designed to offer recommendations or advice, the query (104) may include specific questions or prompts that the user wants the AI agent to address.

Once the front-end (110) receives the query (104), it processes and forwards it to the appropriate components of the multi-user application system (100) for further analysis and generation of a response. The embedding generator (112) creates an embedding based on the query (104), which is then used by the content retrieval module (114) to identify relevant content from the knowledge database (116).

The query (104) also initiates the interaction between the user and the generative AI agent. It serves as the starting point for the system to understand the user's needs, retrieve relevant information, and generate a meaningful response using the LLM service (122).

Throughout the process, the query (104) undergoes various transformations and interpretations within the multi-user application system (100). The front-end (110) handles the initial reception and formatting of the query, while the embedding generator (112) and content retrieval module (114) process the query to extract relevant information and retrieve associated content from the knowledge database (116).

Ultimately, the query (104) drives the generation of the LLM prompt by the answer synthesis module (120), which incorporates the query-relevant content and communication type instructions. This prompt is then sent to the LLM service (122) to generate a response that addresses the user's query (104) in a manner consistent with the associated entity's communication style.

In an embodiment, the query (104) is augmented with the conversation history between the user and the particular generative AI agent. This conversation history represents the previous interactions and exchanges between the user and the AI agent, providing context and continuity to the ongoing dialogue.

To implement this feature, the multi-user application system (100) maintains a log or database that stores the conversation history for each user-agent pair. When a user submits a new query (104) to the system, the front-end (110) or another designated component retrieves the relevant conversation history associated with that user and the selected AI agent.

The conversation history is then processed and integrated with the current query (104) to create an augmented query. This augmentation process involves concatenating or merging the conversation history with the query text, ensuring that the order and temporal sequence of the interactions are preserved.

The augmented query, which now includes both the current query and the conversation history, is passed through the subsequent stages of the method. The embedding generator (112) creates an embedding based on the augmented query, capturing the semantic representation of the entire conversation context.

The content retrieval module (114) uses this embedding to search for relevant content in the knowledge database (116), taking into account not only the current query but also the preceding interactions. This allows the system to retrieve content that is more contextually appropriate and aligned with the ongoing conversation.

The answer synthesis module (120) incorporates the augmented query, along with the retrieved content and communication type instructions, into the LLM prompt. By including the conversation history in the prompt, the LLM service (122) can generate a response that considers the context of the previous interactions, maintaining coherence and consistency throughout the dialogue.

The inclusion of conversation history in the query augmentation process enables the generative AI agent to provide more personalized and context-aware responses. It allows the agent to refer back to previous discussions, maintain a consistent tone and style, and build upon the information exchanged in earlier interactions.

Furthermore, the conversation history can be used to implement additional features, such as anaphora resolution, where the AI agent can correctly interpret and respond to references made to earlier parts of the conversation. It can also enable the agent to track the user's preferences, goals, and previous queries, providing a more seamless and efficient user experience.

In an embodiment, the query augmentation process in the multi-user application system (100) employs natural language understanding techniques to contextualize the current query (104) within the broader conversation history. For example, rather than simply concatenating previous interactions, the techniques may utilize a context-aware semantic parsing mechanism to extract relevant information from the conversation history and integrate it with the current query.

In an embodiment, this contextualization process involves several steps. First, the techniques may analyze the conversation history using a combination of recurrent neural networks (RNNs) and attention mechanisms to identify salient points, key topics, and recurring themes. The techniques may then construct a semantic graph representation of the conversation, capturing the relationships between different concepts and ideas discussed throughout the interaction. The current query (104) may then be mapped onto this semantic graph, allowing the system to understand how it relates to and extends the ongoing conversation.

Based on this semantic analysis, the techniques may generate an augmented query representation that encapsulates both the immediate intent of the current query and the relevant contextual information from the conversation history. This representation may not be a simple concatenation of text, but rather a structured, vector-based encoding that captures the semantic relationships between the current query and the conversation context. This augmented query representation may then be used by the embedding generator (112) to create a context-aware embedding, ensuring that the subsequent content retrieval and response generation processes are informed by the full conversational context, leading to more relevant and coherent responses.

In an embodiment, the query (104) is rewritten in addition to or instead of being augmented with the conversation history between the user and the particular generative AI agent. Query rewriting is a technique used to modify or transform the original query to improve its clarity, specificity, or relevance before further processing by the multi-user application system (100).

The query rewriting process can be performed by a dedicated component within the system, such as a query rewriting module, which is responsible for analyzing and modifying the query (104) based on predefined rules, patterns, or algorithms. This module can be integrated into the front-end (110) or operate as a separate component that receives the query from the front-end (110) and returns the rewritten query.

The query rewriting module applies various techniques to transform the query. These techniques may include any or all of:

Synonym replacement: The module identifies words or phrases in the query that have commonly used synonyms and replaces them with their canonical or standardized equivalents. This helps to normalize the query and improve its chances of matching relevant content in the knowledge database (116).

Query expansion: The module expands the query by adding related terms, keywords, or phrases that are semantically similar to the original query terms. This expansion can be based on predefined rules, statistical co-occurrence data, or domain-specific ontologies. By including additional relevant terms, the expanded query has a higher likelihood of retrieving pertinent content from the knowledge database.

Named entity recognition (NER): The module employs NER techniques to identify and extract named entities, such as person names, organizations, locations, or dates, from the query. These entities can be used to refine the query or provide additional context for content retrieval and response generation.

Grammatical corrections: The module identifies and corrects grammatical errors, spelling mistakes, or typos in the query. This ensures that the query is well-formed and can be effectively processed by subsequent components of the system.

Query segmentation: The module breaks down complex or multi-part queries into smaller, more focused sub-queries. Each sub-query can be processed independently, and the results can be combined to generate a comprehensive response.

Once the query rewriting module has transformed the query, the rewritten query is passed to the subsequent stages of the method. The embedding generator (112) creates an embedding based on the rewritten query, capturing its semantic representation. The content retrieval module (114) uses this embedding to search for relevant content in the knowledge database (116).

The rewritten query, along with the retrieved content and communication type instructions, is incorporated into the LLM prompt by the answer synthesis module (120). The LLM service (122) generates a response based on the rewritten query, ensuring that the generated output is more focused, relevant, and aligned with the user's intent.

Query rewriting can be applied independently or in combination with conversation history augmentation. When used together, the conversation history can provide additional context for query rewriting, allowing the module to consider previous interactions while transforming the current query.

By rewriting the query, the multi-user application system (100) can improve the quality and relevance of the retrieved content and the generated responses. It helps to overcome limitations posed by poorly formulated, ambiguous, or incomplete queries, ultimately enhancing the user experience and the effectiveness of the generative AI agent.

The client device (106) refers to the hardware and software component that enables users to interact with the multi-user application system (100) and access the services provided by the generative AI agents. It serves as the interface between the user and the system, allowing users to submit queries, receive responses, and engage in conversations with the AI agents.

The client device (106) can take various forms, such as a personal computer, laptop, smartphone, tablet, or any other computing device with networking capabilities. These devices typically include a processor, memory, storage, and input/output components that enable them to execute software applications and communicate with remote systems.

To interact with the multi-user application system (100), the client device (106) runs a client application or uses a web browser. The client application is a software program specifically designed to communicate with the system's front-end (110) and facilitate user interactions. It provides a user interface that allows users to input queries, view responses, and manage their conversations with the AI agents.

When a user enters a query (104) through the client application or web browser, the client device (106) sends the query to the front-end (110) of the multi-user application system (100) via the intermediate network (108). The network (108) facilitates the communication between the client device and the system, enabling the exchange of data packets containing the query and response information.

The client device (106) is responsible for handling the user interface and rendering the responses received from the multi-user application system (100). It presents the AI agent's responses in a user-friendly format, such as text, images, or multimedia, depending on the capabilities of the client application and the device itself.

In addition to displaying responses, the client device (106) may also perform local processing tasks to enhance the user experience. For example, it may implement caching mechanisms to store frequently accessed data or previous conversations, reducing the need for network communication and improving response times.

The client device (106) also handles user authentication and security features. It may provide mechanisms for users to log in to their accounts, manage their preferences, and ensure the confidentiality and integrity of their interactions with the multi-user application system (100).

Furthermore, the client device (106) may incorporate additional features and functionalities to support the user's interaction with the generative AI agents. These may include voice recognition for voice-based queries, text-to-speech synthesis for audio responses, or integration with other applications and services to extend the capabilities of the AI agents.

The intermediate network (108) encompasses the communication infrastructure that enables the exchange of data between the client device (106) and the multi-user application system (100). It acts as a conduit for transmitting queries, responses, and other relevant information between the user and the generative AI agents.

The intermediate network (108) can be a combination of various network technologies, protocols, and components, depending on the specific implementation and the scale of the multi-user application environment. It may include local area networks (LANs), wide area networks (WANs), the Internet, or any other interconnected network of computing devices and communication links.

The intermediate network (108) encompasses network devices such as routers, switches, and gateways that facilitate the routing and forwarding of data packets between the client device (106) and the multi-user application system (100). These devices use network protocols, such as Internet Protocol (IP) and Transmission Control Protocol (TCP), to ensure the reliable and efficient delivery of data across the network.

The intermediate network (108) may incorporate various network topologies, such as star, bus, or mesh topologies, depending on the requirements of the multi-user application environment. These topologies determine the arrangement and interconnection of network devices and influence factors such as scalability, redundancy, and performance.

To ensure secure communication between the client device (106) and the multi-user application system (100), the intermediate network (108) may implement security measures such as encryption, authentication, and access control. These measures protect the confidentiality and integrity of the data transmitted over the network, preventing unauthorized access or interception of sensitive information.

The intermediate network (108) may also include network services and components that enhance the functionality and performance of the multi-user application environment. These may include:

Load balancers: Distribute incoming network traffic across multiple servers or instances of the multi-user application system (100) to ensure optimal resource utilization and high availability.

Firewalls: Monitor and control incoming and outgoing network traffic based on predefined security rules, preventing unauthorized access and protecting the system from potential threats.

Content delivery networks (CDNs): Distribute content, such as static assets or frequently accessed data, across geographically dispersed servers to improve response times and reduce latency for users accessing the system from different locations.

Network monitoring and management tools: Provide visibility into network performance, troubleshoot issues, and ensure the smooth operation of the intermediate network (108).

The intermediate network (108) enables the communication and interaction between the client device (106) and the multi-user application system (100). It provides the infrastructure and protocols to facilitate the exchange of queries, responses, and other data, ensuring that users can seamlessly interact with the generative AI agents.

The performance and reliability of the intermediate network (108) directly impact the user experience and the effectiveness of the multi-user application environment. Factors such as network bandwidth, latency, and congestion can affect the responsiveness and quality of the interactions between users and AI agents.

The front-end (110) serves as the interface between the client device (106) and the system's backend components. It is responsible for handling the communication and data exchange between the user and the generative AI agents.

The front-end (110) may be implemented as a software module or a set of modules that run on the multi-user application system (100). It is designed to handle incoming requests from the client device (106), process those requests, and coordinate the interaction between the user and the AI agents.

When a user sends a query (104) from the client device (106), the front-end (110) receives the query via the intermediate network (108). The front-end (110) is responsible for parsing and validating the incoming query, ensuring that it is well-formed and contains the necessary information for further processing.

Once the query is validated, the front-end (110) may perform additional preprocessing tasks, such as formatting the query, extracting relevant metadata, or applying security measures to protect against potential threats or unauthorized access.

The front-end (110) then forwards the preprocessed query to the appropriate backend components of the multi-user application system (100), such as the embedding generator (112) or the content retrieval module (114). These components process the query further, generate an embedding, retrieve relevant content from the knowledge database (116), and synthesize a response using the LLM service (122).

After the backend components have generated a response, the front-end (110) receives the response from the answer synthesis module (120). The front-end (110) is responsible for formatting the response in a way that is suitable for transmission to the client device (106). This may involve converting the response into a specific data format, such as JSON or XML, or applying any necessary transformations or optimizations to ensure efficient transmission over the network.

The front-end (110) then sends the formatted response (124) back to the client device (106) via the intermediate network (108). The response is delivered to the user through the client application or web browser running on the client device (106).

In addition to handling the incoming queries and outgoing responses, the front-end (110) may also perform other tasks related to user interaction and communication. These may include any or all of the following tasks:

Authentication and authorization: Verifying the identity of the user and ensuring that they have the necessary permissions to access the multi-user application system (100) and interact with the AI agents.

Session management: Maintaining and managing user sessions, ensuring that the user's state and context are preserved across multiple interactions with the system.

Error handling and logging: Capturing and handling errors that may occur during the processing of queries or the generation of responses, and logging relevant information for debugging and monitoring purposes.

Caching and performance optimization: Implementing caching mechanisms to store frequently accessed data or responses, reducing the load on the backend components and improving the overall performance of the system.

The embedding generator (112) generates a dense vector representation, known as an embedding, based on the query (104) received by the front-end (110). The purpose of the embedding generator (112) is to convert the textual query into a numerical vector format that captures the semantic meaning and contextual information of the query.

In an embodiment, the embedding generator (112) employs various techniques and algorithms to generate the embedding. One possible approach is to use word embeddings, such as Word2Vec or GloVe, which map individual words to dense vectors in a high-dimensional space. These word embeddings are pre-trained on large corpora of text data and capture the semantic relationships between words based on their co-occurrence patterns.

To generate an embedding for the entire query, the embedding generator (112) can utilize sentence embedding techniques, such as averaging or concatenating the word embeddings of the individual words in the query. This results in a single vector representation that encodes the overall meaning of the query.

Another possible approach for generating embeddings is to use transformer-based models, such as BERT (Bidirectional Encoder Representations from Transformers) or its variants. These models are pre-trained on large amounts of text data using self-supervised learning techniques, allowing them to capture semantic and contextual information.

The embedding generator (112) can fine-tune a pre-trained transformer model on domain-specific data relevant to the multi-user application system (100) to adapt it to the specific requirements of the application. By inputting the query (104) into the fine-tuned transformer model, the embedding generator (112) obtains a contextualized embedding that incorporates the nuances and characteristics of the application domain.

The resulting embedding generated by the embedding generator (112) is a dense vector of fixed dimensionality, typically ranging from a few hundred to a few thousand dimensions. This compact representation allows for efficient similarity comparisons and retrieval operations in the subsequent stages of the multi-user application system (100).

The embedding generated by the embedding generator (112) is then passed to the content retrieval module (114), which uses it to search for and retrieve query-relevant content from the knowledge database (116). The embedding serves as a numerical representation of the query's meaning, enabling the content retrieval module (114) to find semantically similar content in the database.

The quality and effectiveness of the embeddings generated by the embedding generator (112) capture the semantic nuances and relationships of the query, leading to more accurate content retrieval and ultimately contributing to the generation of relevant and coherent responses by the LLM service (122).

The embedding generator (112) may also incorporate techniques for handling out-of-vocabulary words, dealing with misspellings or typos, and normalizing the input query to improve the robustness and reliability of the generated embeddings.

The content retrieval module (114) retrieves query-relevant content associated with the entity from the knowledge database (116). The content retrieval module (114) plays a crucial role in identifying and fetching the most relevant information based on the embedding generated by the embedding generator (112).

The content retrieval module (114) takes the embedding as input, which serves as a numerical representation of the query's semantic meaning and contextual information. The module then uses this embedding to search for and retrieve content from the knowledge database (116) that is most similar or relevant to the query.

The knowledge database (116) is a repository that stores content (118) associated with the entity. This content can include various types of information, such as text documents, articles, FAQs, product descriptions, or any other relevant data specific to the entity. The content in the knowledge database (116) is typically pre-processed and indexed to facilitate efficient retrieval operations.

The content retrieval module (114) employs similarity search algorithms or techniques to compare the query embedding with the embeddings or representations of the content stored in the knowledge database (116). Possible approaches for similarity search include cosine similarity, Euclidean distance, or dot product similarity.

The similarity search process involves computing the similarity scores between the query embedding and the content embeddings in the knowledge database (116). The content retrieval module (114) then ranks the content based on their similarity scores and retrieves the top-k most relevant items, where k is a predefined number or a threshold determined by the system.

The retrieved content may be structured in a way that preserves the original context and metadata associated with each item. This can include information such as the title, source, timestamp, or any other relevant attributes that provide additional context to the retrieved content.

The content retrieval module (114) may also employ techniques such as term frequency-inverse document frequency (TF-IDF) weighting or BM25 ranking to further refine the relevance scoring and ranking of the retrieved content. These techniques consider factors such as the frequency and importance of query terms within the content and the overall corpus.

In some cases, the content retrieval module (114) may incorporate additional filters or constraints to narrow down the retrieved content based on specific criteria, such as date range, content type, or domain-specific attributes. This helps to ensure that the retrieved content is not only relevant to the query but also aligns with the specific requirements or context of the multi-user application system (100).

The content retrieval module (114) may also implement caching mechanisms to store frequently accessed or recently retrieved content, reducing the latency and improving the efficiency of subsequent retrieval operations.

Once the content retrieval module (114) has retrieved the most relevant content based on the query embedding, it passes this content to the answer synthesis module (120). The answer synthesis module (120) then uses the retrieved content, along with the query and communication type information, to generate an appropriate response using the LLM service (122).

The effectiveness of the content retrieval module (114) directly impacts the quality and relevance of the responses generated by the multi-user application system (100). By accurately identifying and retrieving the most pertinent content from the knowledge database (116), the content retrieval module (114) enables the system to provide informative and context-specific responses to user queries.

The knowledge database (116) serves as a repository for storing and managing the content (118) associated with the entity. It is designed to facilitate efficient retrieval of relevant content based on the embeddings generated from user queries.

The knowledge database (116) is optimized for embedding-based retrieval, which means that it is structured and organized in a way that enables quick and accurate retrieval of content using the semantic representations captured by the embeddings.

To achieve this optimization, the knowledge database (116) employs techniques such as vector indexing or approximate nearest neighbor search algorithms. These techniques allow for fast similarity search and retrieval of content based on the proximity of the query embedding to the content embeddings in the vector space.

The content (118) stored in the knowledge database (116) is preprocessed and transformed into a suitable format that facilitates embedding-based retrieval. This preprocessing step may involve tasks such as text normalization, tokenization, and feature extraction to convert the raw content into a representation that can be efficiently compared with the query embeddings.

Additionally, the knowledge database (116) may utilize data structures such as inverted indexes, which map each unique term or concept to its corresponding content items. These indexes enable quick lookups and retrieval of relevant content based on the terms or concepts present in the query embedding.

The knowledge database (116) may also incorporate techniques like dimensionality reduction or clustering to organize the content embeddings in a way that enhances the efficiency of the retrieval process. By reducing the dimensionality of the embeddings or grouping similar content together, the system can minimize the search space and improve the speed and scalability of the retrieval operation.

Furthermore, the knowledge database (116) may employ caching mechanisms to store frequently accessed or recently retrieved content embeddings in memory. Caching helps reduce the latency of subsequent retrieval requests by avoiding the need to recalculate the embeddings or perform expensive database operations.

The knowledge database (116) is designed to handle large volumes of content and support high-throughput retrieval requests. It may utilize distributed storage and processing frameworks to scale horizontally and accommodate the growing amount of content associated with the entity.

The retrieval process in the knowledge database (116) involves comparing the query embedding generated by the embedding generator (112) with the content embeddings stored in the database. The comparison is performed using similarity metrics such as cosine similarity or Euclidean distance to determine the relevance of each content item to the query.

The content retrieval module (114) interacts with the knowledge database (116) to perform the actual retrieval operation. It sends the query embedding to the database and receives the top-k most relevant content items based on the similarity scores. The retrieved content is then used by the answer synthesis module (120) to generate the response to the user's query.

By optimizing the knowledge database (116) for embedding-based retrieval, the system can efficiently search and retrieve relevant content from a large corpus of information. The embedding-based approach enables semantic matching and allows for more accurate and contextually relevant content retrieval compared to traditional keyword-based search methods.

The content (118) encompasses the information stored in the knowledge database (116) that is associated with the entity. It encompasses the actual data, information, or knowledge that is relevant to the entity's domain or scope and is used to generate responses to user queries.

The content (118) can encompass various types of data, depending on the nature of the entity and the specific requirements of the multi-user application system (100). It can include structured or unstructured data in different formats, such as data in any or all of the following formats:

Text documents: The content (118) may include textual information in the form of articles, blog posts, news updates, product descriptions, user manuals, or any other written material that is relevant to the entity. These text documents can be stored in plain text format, HTML, or other document formats like PDF or Word.

FAQs: Frequently Asked Questions (FAQs) are a common type of content (118) that provides concise answers to commonly asked questions related to the entity. FAQs can cover a wide range of topics, such as product information, troubleshooting guides, or general information about the entity.

Structured data: The content (118) may also include structured data stored in databases or other organized formats. This can include product catalogs, customer records, transaction histories, or any other structured information that is relevant to the entity and can be used to generate informative responses.

Multimedia content: In some cases, the content (118) may include multimedia elements such as images, videos, or audio files that are relevant to the entity. These multimedia assets can be stored alongside the textual content or linked through references in the knowledge database (116).

The content (118) may be organized and stored in a way that facilitates efficient retrieval and processing by the multi-user application system (100). This may involve structuring the content using appropriate data models, schemas, or metadata that describe the attributes, relationships, and context of each piece of content.

The content (118) may be pre-processed or transformed before being stored in the knowledge database (116) to optimize retrieval and analysis. This pre-processing can include tasks such as text normalization, tokenization, removing stop words, or extracting relevant features or keywords from the content.

The content retrieval module (114) utilizes the embedding generated by the embedding generator (112) to search for and retrieve the most relevant content (118) from the knowledge database (116) based on the user's query. The retrieved content (118) is then used by the answer synthesis module (120) to generate an appropriate response using the LLM service (122).

The quality, relevance, and comprehensiveness of the content (118) directly impact the accuracy and effectiveness of the responses generated by the multi-user application system (100). The content (118) may be sourced from various internal or external sources, such as existing databases, web scraping, user-generated content, or manually curated by domain experts. Content (118) may be regularly updated, maintained, and aligned with the evolving needs and requirements of the entity and its users.

The answer synthesis module (120) a component of the multi-user application system (100) that generates a large language model (LLM) prompt using the query-relevant content retrieved by the content retrieval module (114) and the communication type associated with the entity. The answer synthesis module (120) constructs an appropriate prompt that guides the LLM service (122) to generate a response aligned with the entity's communication style.

The answer synthesis module (120) takes several inputs, including the query-relevant content retrieved from the knowledge database (116), the original query (104) received by the front-end (110), and the determined communication type associated with the entity. The communication type represents the desired style, tone, or manner in which the entity communicates with users.

To generate the LLM prompt, the answer synthesis module (120) processes and combines the query-relevant content and the original query (104) in a structured format. This may involve techniques such as concatenating the content and query, applying templates or predefined formats, or using specific delimiters to separate different parts of the prompt.

In addition to the content and query, the answer synthesis module (120) incorporates instructions or directives into the LLM prompt to guide the LLM service (122) in generating a response that adheres to the entity's communication type. These instructions may specify the desired tone, style, level of formality, or any other relevant aspects of the communication.

For example, if the communication type associated with the entity is “professional and concise,” the answer synthesis module (120) may include instructions in the LLM prompt such as “Please provide a concise and professional response to the following query: [query]” or “Generate a response in a formal and succinct manner based on the provided content: [content].”

In an embodiment, the answer synthesis module (120) implements an inference engine that complements the explicit communication type instructions. This engine may employ natural language processing (NLP) and machine learning techniques to analyze the corpus of content associated with the expert agent, including self-generated material, endorsed content, and positively received contributions from others. The analysis may involve text mining algorithms, including term frequency-inverse document frequency (TF-IDF) analysis, latent semantic indexing (LSI), and deep learning-based language models to extract latent stylistic features.

The style inference process may utilize a multi-layered approach. At the lexical level, it may examine vocabulary choices, idiomatic expressions, and domain-specific terminology. Syntactically, it may analyze sentence structures, clause complexity, and rhetorical devices. At the discourse level, it may evaluate argumentation patterns, narrative structures, and coherence markers. Additionally, sentiment analysis and emotion detection algorithms may be applied to capture the affective dimensions of the expert agent's communication style.

The derived stylistic profile may then be encoded into a high-dimensional vector or other suitable representation, which is integrated into the LLM prompt generation process. This integration may be achieved through a prompt augmentation technique that interleaves the inferred stylistic features with the query-relevant content and explicit communication type instructions. The augmented prompt structure may include style-specific tokens, weighted emphasis on characteristic phrases, or fine-grained control parameters that guide the LLM in emulating the expert agent's unique communication style. This approach may enable the LLM to generate responses that not only adhere to explicit guidelines but also organically reflect the nuanced, implicit aspects of the expert agent's characteristic expression, thereby enhancing the authenticity and consistency of the AI-generated communication.

The answer synthesis module (120) may also apply techniques such as prompt engineering or template-based generation to optimize the structure and content of the LLM prompt. This involves designing effective prompt templates or patterns that elicit the desired type of response from the LLM service (122) while incorporating the necessary context and instructions.

Once the LLM prompt is generated, the answer synthesis module (120) submits it to the LLM service (122) for processing. The LLM service (122) is a powerful language model trained on vast amounts of text data, capable of generating human-like responses based on the provided prompt.

The LLM service (122) takes the prompt generated by the answer synthesis module (120) and uses its trained model to generate a response. The LLM service (122) considers the context provided in the prompt, including the query-relevant content and the communication type instructions, to generate a response that is coherent, relevant, and aligned with the entity's communication style.

In an embodiment, the answer synthesis module (120) employs a prompt engineering technique that orchestrates a two-phase response generation process within a single LLM service (122) call. This approach uses the LLM service (122)'s ability to follow complex, multi-step instructions while maintaining context coherence.

The generated LLM prompt is structured as a sequence of distinct directives. In the first phase, the prompt instructs the LLM service (122) to synthesize an initial response based solely on the query-relevant content retrieved from the knowledge database. This intermediate LLM output is explicitly directed to be stored in a temporary variable within the LLM service (122)'s working memory. This phase focuses on content accuracy and relevance, so that the response is grounded in the entity-specific knowledge base.

The second phase of the prompt activates a style transformation mechanism. It instructs the LLM service (122) to retrieve the content from the temporary variable and apply the expert agent's specific communication style to this intermediate response. This stylistic adaptation process incorporates the previously determined communication type and any inferred stylistic features. The LLM service (122) then generates the response, which maintains the factual integrity of the initial LLM output while embodying the characteristic linguistic patterns, tone, and rhetorical structures of the expert agent. This two-phase approach within a single LLM call allows for a balance between content fidelity and stylistic authenticity in the generated output.

After generating the response, the LLM service (122) returns the generated output to the answer synthesis module (120). The answer synthesis module (120) may perform post-processing on the generated output, such as formatting, filtering, or applying any necessary transformations to ensure the response is in a suitable format for presentation to the user.

The answer synthesis module (120) passes the generated response to the front-end (110), which sends it back to the client device (106) as the response (124) to the original query (104).

The LLM service is a component of the multi-user application system (100) that generates a response based on the LLM prompt provided by the answer synthesis module (120). The LLM service (122) utilizes a large language model (LLM), which is a deep learning model trained on vast amounts of text data to generate human-like responses.

The LLM used by the LLM service (122) may be a transformer-based model, such as GPT (Generative Pre-trained Transformer) or its variants. These models have a deep neural network architecture that allows them to learn and capture the intricacies of human language, including syntax, semantics, and context.

The LLM may be pre-trained on a massive corpus of text data, which can include books, articles, websites, and other sources of written content. During the pre-training phase, the model learns to predict the next word or token in a sequence based on the preceding words or tokens. This process enables the model to learn the statistical patterns and relationships within the language.

Once pre-trained, the LLM can be fine-tuned on specific domains or tasks to adapt its knowledge to the particular requirements of the multi-user application system (100). Fine-tuning involves training the model on a smaller dataset relevant to the entity or the application domain, allowing it to specialize in generating responses aligned with the desired communication style and context.

When the LLM service (122) receives the LLM prompt from the answer synthesis module (120), it feeds the prompt into the LLM. The LLM processes the prompt by iteratively generating the response word by word or token by token. At each step, the model predicts the most likely next word based on the context provided by the prompt and the previously generated words.

The LLM service (122) employs techniques such as beam search, top-k sampling, or nucleus sampling to generate the response. These techniques help balance the trade-off between the quality and diversity of the generated output. Beam search maintains multiple candidate responses and selects the most likely one based on a scoring function. Top-k sampling restricts the sampling space to the top k most likely next words, while nucleus sampling sets a probability threshold and samples from the smallest set of words whose cumulative probability exceeds that threshold.

The LLM service (122) generates the response by considering the context provided in the LLM prompt, including the query-relevant content, the original query (104), and the instructions related to the communication type. The model aims to generate a response that is coherent, relevant, and aligned with the specified communication style.

The generated response is then returned to the answer synthesis module (120) for further processing and delivery to the user via the front-end (110) and the client device (106).

The LLM service (122) can handle various types of queries and generate responses across different domains and contexts. Its ability to generate human-like responses is based on the vast knowledge it has acquired during the pre-training phase and the specific fine-tuning it undergoes for the multi-user application system (100).

The quality and effectiveness of the responses generated by the LLM service (122) depend on factors such as the size and quality of the pre-training data, the architecture and hyperparameters of the LLM, and the specific fine-tuning process applied.

The response (124) encompasses the output generated by the multi-user application system (100) in response to the user's query (104). It is the culmination of the processing performed by various components of the system, including the front-end (110), embedding generator (112), content retrieval module (114), answer synthesis module (120), and LLM service (122).

The response (124) is generated based on the LLM output produced by the LLM service (122). The LLM service (122) takes the LLM prompt created by the answer synthesis module (120), which includes the query-relevant content, the original query (104), and the instructions related to the communication type associated with the entity. The LLM service (122) processes this prompt and generates a response that aims to be informative, relevant, and aligned with the specified communication style.

The generated LLM output is then passed back to the answer synthesis module (120), which may perform additional processing or formatting on the response. This post-processing step ensures that the response is in a suitable format for presentation to the user.

The response (124) typically consists of natural language text that addresses the user's query (104) and provides the requested information or assistance. The content of the response is based on the relevant information retrieved from the knowledge database (116) by the content retrieval module (114) and the knowledge captured by the LLM during its training phase.

The structure and format of the response (124) may vary depending on the specific implementation of the multi-user application system (100) and the requirements of the entity. It could be a plain text response, or it may include additional elements such as formatting, links, or multimedia content to enhance the user experience.

The response (124) is returned to the user via the front-end (110) of the multi-user application system (100). The front-end (110) sends the response back to the client device (106) over the intermediate network (108). The client device (106) then displays the response to the user through its user interface, such as a chat window or a messaging application.

The response (124) aims to provide a satisfactory and helpful answer to the user's query (104), assisting them in obtaining the information or guidance they seek. The multi-user application system (100) strives to generate responses that are contextually appropriate, linguistically coherent, and tailored to the specific needs of the user and the entity.

Step 1 of the method of FIG. 1 involves receiving a selection of a generative AI agent at the multi-user application system (100) within a multi-user application environment. The multi-user application system (100) is implemented using one or more programmable electronic devices (102), which provide the necessary computational resources and infrastructure to support the system's functionality.

The selection of the generative AI agent is made from a set of one or more available generative AI agents. This set may include multiple AI agents, each associated with a specific entity or designed to cater to different domains, knowledge areas, or communication styles. The user or the system itself can make the selection based on criteria such as the user's preferences, the nature of the query, or the desired outcome.

The selected generative AI agent is associated with an entity, which can be an individual, an organization, a brand, or any other relevant party. The association between the AI agent and the entity implies that the agent is designed to represent or emulate the communication style, knowledge, and characteristics of that specific entity.

The receiving of the selection at the multi-user application system (100) can be implemented through various mechanisms, such as user input via a user interface, API calls, or system configuration settings. The system (100) may have predefined endpoints or interfaces that allow for the selection of the desired generative AI agent.

Upon receiving the selection, the multi-user application system (100) identifies and activates the corresponding generative AI agent associated with the selected entity. This activation process may involve loading the necessary models, configurations, and knowledge bases specific to that AI agent, preparing it to handle incoming queries and generate responses.

Step 2 of the method of FIG. 1 involves receiving a query (104) from a client device (106) by the front-end (110) of the multi-user application system (100). The multi-user application environment consists of three main components: the client device (106), an intermediate network (108), and the multi-user application system (100).

The client device (106) is the hardware and software component that enables the user to interact with the multi-user application system (100). It can be a computer, smartphone, tablet, or any other device capable of sending queries and receiving responses over a network. The client device (106) runs a client application or uses a web browser to communicate with the multi-user application system (100).

The intermediate network (108) is the communication infrastructure that facilitates the exchange of data between the client device (106) and the multi-user application system (100). It can include local area networks (LANs), wide area networks (WANs), the Internet, or any combination of network technologies and protocols that enable the transmission of queries and responses.

The query (104) is sent by the client device (106) over the intermediate network (108) to the multi-user application system (100). The query (104) represents the user's input or request, typically in the form of text or voice, seeking information or assistance from the generative AI agent selected in Step 1.

The front-end (110) of the multi-user application system (100) is responsible for receiving the query (104) from the client device (106). It acts as the interface between the user and the system, handling the communication protocols and data exchange. The front-end (110) may perform tasks such as parsing the query, validating its format, and preprocessing it for further analysis.

Upon receiving the query (104), the front-end (110) may perform additional processing steps, such as authentication, authorization, or session management, to ensure the security and integrity of the interaction between the client device (106) and the multi-user application system (100).

Once the query (104) is received and processed by the front-end (110), it is forwarded to the subsequent components of the multi-user application system (100) for further analysis and generation of a response.

Step 3 of the method of FIG. 1 involves generating an embedding based on the query (104) received in <step2>. This step is performed by the embedding generator (112), which is a component of the multi-user application system (100).

An embedding is a dense vector representation of the query (104) that captures its semantic meaning and contextual information. The purpose of generating an embedding is to convert the textual query into a numerical format that can be efficiently processed and compared by the system.

The embedding generator (112) employs various techniques and algorithms to generate the embedding. One common approach is to use word embeddings, such as Word2Vec or GloVe, which map individual words in the query to dense vectors in a high-dimensional space. These word embeddings are pre-trained on large corpora of text data and capture the semantic relationships between words based on their co-occurrence patterns.

To generate an embedding for the entire query (104), the embedding generator (112) combines the word embeddings of the individual words in the query. This can be done through techniques such as averaging or concatenating the word embeddings, or by using more advanced methods like recurrent neural networks (RNNs) or transformers to capture the sequential and contextual information of the words in the query.

As indicated above, another approach for generating embeddings is to use sentence embedding models, such as BERT (Bidirectional Encoder Representations from Transformers) or its variants. These models are pre-trained on large amounts of text data and can generate contextualized embeddings that capture the meaning of the query as a whole, considering the relationships and dependencies between the words.

The embedding generator (112) may also apply preprocessing techniques to the query (104) before generating the embedding. This can include text normalization, tokenization, removing stop words, or handling out-of-vocabulary words. These preprocessing steps help to standardize the input and improve the quality of the generated embedding.

The resulting embedding generated by the embedding generator (112) is a dense vector of fixed dimensionality, typically ranging from a few hundred to a few thousand dimensions. This compact representation allows for efficient storage, retrieval, and comparison of queries in the subsequent steps of the method.

The generated embedding is then passed to the content retrieval module (114) in Step 4, where it will be used to retrieve query-relevant content from the knowledge database (116) associated with the selected generative AI agent.

Step 4 of the method of FIG. 1 involves using the embedding generated in Step 4 to retrieve query-relevant content associated with the entity from a knowledge database (116). This step is performed by the content retrieval module (114), which is a component of the multi-user application system (100).

The knowledge database (116) is a repository that stores content (118) associated with the entity. This content can include various types of information, such as text documents, articles, FAQs, product descriptions, or any other relevant data specific to the entity. The content (118) in the knowledge database (116) may be organized and indexed to facilitate efficient retrieval based on the query embeddings.

The content retrieval module (114) takes the embedding generated by the embedding generator (112) as input. This embedding represents the semantic meaning and contextual information of the query (104) in a dense vector format. The content retrieval module (114) uses this embedding to search for and retrieve the most relevant content from the knowledge database (116).

To perform the retrieval, the content retrieval module (114) employs similarity search techniques. It compares the query embedding with the embeddings or representations of the content (118) stored in the knowledge database (116). The comparison is typically done using similarity metrics such as cosine similarity, dot product, or Euclidean distance. These metrics measure the proximity or similarity between the query embedding and the content embeddings in the high-dimensional vector space.

The content retrieval module (114) computes the similarity scores between the query embedding and the content embeddings and ranks the content based on their relevance to the query. It may employ additional techniques, such as TF-IDF (Term Frequency-Inverse Document Frequency) weighting or BM25 (Best Matching 25) ranking, to further refine the relevance scoring and prioritize the most informative and pertinent content.

Based on the computed similarity scores and ranking, the content retrieval module (114) retrieves the top-k most relevant content items from the knowledge database (116). The value of k is a hyperparameter that determines the number of content items to retrieve. It can be adjusted based on factors such as the desired level of information coverage, the complexity of the query, or the available computational resources.

The retrieved content may be stored in a structured format, such as JSON or XML, which includes the text content along with metadata such as the title, source, timestamp, or other relevant attributes. This structured representation allows for easy integration and processing of the retrieved content in the subsequent steps of the method.

The retrieved query-relevant content is then passed to the answer synthesis module (120) in Step 6, where it will be used to generate an appropriate response to the user's query (104) using the LLM service (122).

Step 5 of the method of FIG. 1 involves determining a communication type associated with the entity at the multi-user application system (100). The communication type represents the style, tone, or manner in which the entity communicates with users.

The determination of the communication type tailors the response generated by the generative AI agent to align with the entity's preferred way of interacting with users. It helps to maintain consistency and authenticity in the communication between the user and the entity.

The multi-user application system (100) may employ various techniques to determine the communication type associated with the entity. One approach is to have a predefined mapping or configuration that associates each entity with a specific communication type. This mapping can be based on the entity's characteristics, industry, target audience, or communication guidelines.

For example, if the entity is a healthcare provider, the associated communication type may be set to “professional” or “empathetic” to ensure that the responses generated by the AI agent are informative, trustworthy, and sensitive to the user's needs. On the other hand, if the entity is an entertainment brand, the communication type may be set to “casual” or “humorous” to reflect a more engaging and lighthearted tone.

Another approach to determine the communication type is through machine learning techniques. The multi-user application system (100) can analyze historical interactions, or a corpus of communication data associated with the entity to identify patterns, language styles, and commonly used phrases. By training a machine learning model on this data, the system can automatically infer the communication type that best represents the entity's communication style.

The determination of the communication type may also involve considering the context and nature of the user's query (104). Different types of queries may warrant different communication types. For example, a query related to a serious or sensitive topic may require a more formal and empathetic communication type, while a query related to a casual or entertaining topic may allow for a more relaxed and humorous communication type.

Once the communication type is determined, it is used in the subsequent steps of the method to guide the generation of the response by the generative AI agent. In Step 6, the communication type is incorporated into the LLM prompt along with the query-relevant content retrieved in Step 4. The LLM service (122) then applies the communication type to the generated response to ensure that it aligns with the entity's preferred communication style.

Step 6 of the method of FIG. 1 involves generating a large language model (LLM) prompt by the answer synthesis module (120) of the multi-user application system (100). The LLM prompt comprises the query-relevant content retrieved in Step 4 and instructions to apply the communication type determined in Step 5 to the LLM output.

The answer synthesis module (120) may be responsible for constructing the LLM prompt that will be used to generate the response to the user's query (104). The LLM prompt is a structured input that combines the necessary information and instructions to guide the LLM service (122) in generating a relevant and coherent response.

To generate the LLM prompt, the answer synthesis module (120) takes the query-relevant content retrieved from the knowledge database (116) in Step 4. This content provides the informational basis for generating the response. The answer synthesis module (120) processes and organizes the retrieved content into a format suitable for inclusion in the LLM prompt.

In addition to the query-relevant content, the answer synthesis module (120) incorporates instructions into the LLM prompt to apply the communication type determined in Step 5. These instructions guide the LLM service (122) to generate a response that aligns with the entity's preferred communication style.

The instructions can be in the form of specific directives, templates, or examples that demonstrate how to apply the communication type to the generated response. For instance, if the communication type is determined to be “professional,” the instructions may include guidelines such as using formal language, avoiding slang or colloquialisms, and presenting information in a clear and concise manner.

The answer synthesis module (120) structures the LLM prompt by combining the query-relevant content and the communication type instructions in a way that is understandable and actionable by the LLM service (122). This may involve using specific delimiters, tags, or formatting conventions to separate the content and instructions within the prompt. For example, the LLM prompt may be structured as follows:
′′′
<content>
[Retrieved query-relevant content goes here.]
</content>
<query>

Using <content> as background and contextual information, generate a response to the following query:
[Prompt to elicit response to user's query goes here.]
</query>
<instructions>

Regenerate the response by applying the following communication type to the generated response to the query:
Communication Type: [Determined communication type goes here]
Guidelines: [Specific instructions or examples for applying the communication type go here]
</instructions>
′′′

The answer synthesis module (120) may also include additional context or metadata in the LLM prompt, such as the user's query (104) itself, to provide further guidance to the LLM service (122) in generating a relevant response.

Once the LLM prompt is generated, it is passed to the LLM service (122) in <step7> for processing and generation of the response. The LLM service (122) takes the prompt as input and generates a response that incorporates the query-relevant content and applies the specified communication type.

Step 7 of the method of FIG. involves receiving a particular LLM output from the LLM service (122) by the answer synthesis module (120) in response to submitting the LLM prompt generated in Step 6. The LLM output reflects the application of the communication type by the LLM service (122) to the generated response.

The LLM service (122) is a component of the multi-user application system (100) that utilizes a large language model (LLM) to generate human-like responses based on the provided LLM prompt. LLMs are deep learning models trained on vast amounts of text data, allowing them to understand and generate natural language responses.

Upon receiving the LLM prompt from the answer synthesis module (120), the LLM service (122) processes the prompt and uses it as input to generate a response. The LLM prompt contains the query-relevant content and instructions for applying the communication type, as specified in Step 6.

The LLM service (122) leverages the knowledge and language understanding capabilities of the underlying LLM to analyze the prompt and generate a coherent and relevant response. The LLM has been pre-trained on a large corpus of text data, allowing it to understand the context and semantics of the prompt and generate a response that is linguistically coherent and meaningful.

During the generation process, the LLM service (122) takes into account the communication type instructions provided in the LLM prompt. It applies the specified communication type to the generated response, ensuring that the response aligns with the entity's preferred communication style.

For example, if the communication type is “professional,” the LLM service (122) generates a response that uses formal language, maintains a serious tone, and presents information in a structured and concise manner. If the communication type is “casual,” the LLM service (122) may generate a response that is more conversational, uses simpler language, and includes friendly or humorous elements.

The LLM service (122) generates the response by iteratively predicting the next word or token based on the context provided by the LLM prompt and the previously generated words. It uses techniques such as beam search, top-k sampling, or nucleus sampling to explore different possible responses and select the most appropriate one based on the given prompt and communication type.

The generated LLM output is then received by the answer synthesis module (120). The answer synthesis module (120) may perform additional processing or formatting on the LLM output to ensure that it is in a suitable format for presentation to the user.

The LLM output received in Step 7 represents the application of the communication type to the generated response. It reflects the LLM service's (122) ability to understand the context provided by the LLM prompt and generate a response that incorporates the query-relevant content while adhering to the specified communication style.

Step 8 of the method of FIG. 1 involves returning a response (124) to the user's query (104) by the front-end (110) of the multi-user application system (100). The response (124) is based on the particular LLM output received from the LLM service (122) in Step 7.

After receiving the LLM output from the answer synthesis module (120) in Step 7, the front-end (110) prepares the response to be sent back to the user. The front-end (110) is responsible for formatting and packaging the response in a way that is suitable for transmission over the intermediate network (108) and presentation on the client device (106).

The front-end (110) takes the LLM output and may perform additional processing or transformation on it to ensure that the response is in a format that can be easily consumed by the client device (106). This may involve converting the LLM output into a specific data format, such as JSON or XML, which can be parsed and rendered by the client application or web browser running on the client device (106).

In some cases, the front-end (110) may also apply additional formatting or styling to the response (124) to enhance its readability and visual appeal. This can include adding headers, paragraphs, lists, or other structural elements to organize the information in a clear and presentable manner.

In an embodiment, the response generation process incorporates formatting instructions directly within the LLM prompt, ensuring that the output is structured and styled appropriately without requiring post-processing by the front-end (110). This approach utilizes the LLM service (122)'s ability to understand and execute formatting directives alongside content generation.

The answer synthesis module (120) may integrate specific formatting instructions into the LLM prompt, utilizing a custom markup language or predefined formatting tokens. These instructions may include directives for creating headers, paragraphs, lists, emphasis, and other structural elements. The LLM may be trained or configured to interpret these formatting instructions and incorporate them into the generated response, producing a structured output that adheres to the desired presentation style.

Upon receiving the response (124), the front-end (110) may function as a rendering engine, interpreting the formatting characters and structures embedded within the response. It may translate these formatting instructions into appropriate HTML, CSS, or other display-specific code, depending on the client device (106)'s requirements. This approach may ensure consistency in formatting across different platforms and devices while maintaining the integrity of the LLM-generated structure. The front-end (11)'s in this case may be limited to faithful rendering of the pre-formatted response (124), without making any significant transformations to the content's organization or visual presentation.

If the LLM output contains any special characters, formatting tags, or escape sequences, the front-end (110) handles them appropriately to ensure that the response (124) is properly formatted and free from any unintended artifacts.

The front-end (110) may also perform any necessary encoding or compression on the response (124) to optimize its transmission over the network. This can involve using techniques such as gzip compression or chunked transfer encoding to reduce the size of the response and improve the efficiency of data transfer.

Once the response (124) is properly formatted and prepared, the front-end (110) sends it back to the client device (106) over the intermediate network (108). The response (124) is transmitted using the appropriate communication protocols, such as HTTP or WebSocket, depending on the requirements of the multi-user application system (100) and the capabilities of the client device (106).

The client device (106) receives the response (124) from the front-end (110) and displays it to the user through its user interface. The user can then view the response, which addresses their original query (104) and provides the requested information or assistance.

Step 8 completes the end-to-end process of handling the user's query (104) and generating a relevant response (124) using the generative AI agent associated with the entity. The response (124) incorporates the query-relevant content, applies the specified communication type, and is returned to the user in a format that is easy to understand and interact with.

By returning the response (124) to the user, the multi-user application system (100) fulfills its purpose of providing informative and helpful assistance to the user based on their query. The response (124) represents the culmination of the various steps involved in the method, from receiving the query, generating an embedding, retrieving relevant content, determining the communication type, generating an LLM prompt, and obtaining the LLM output.

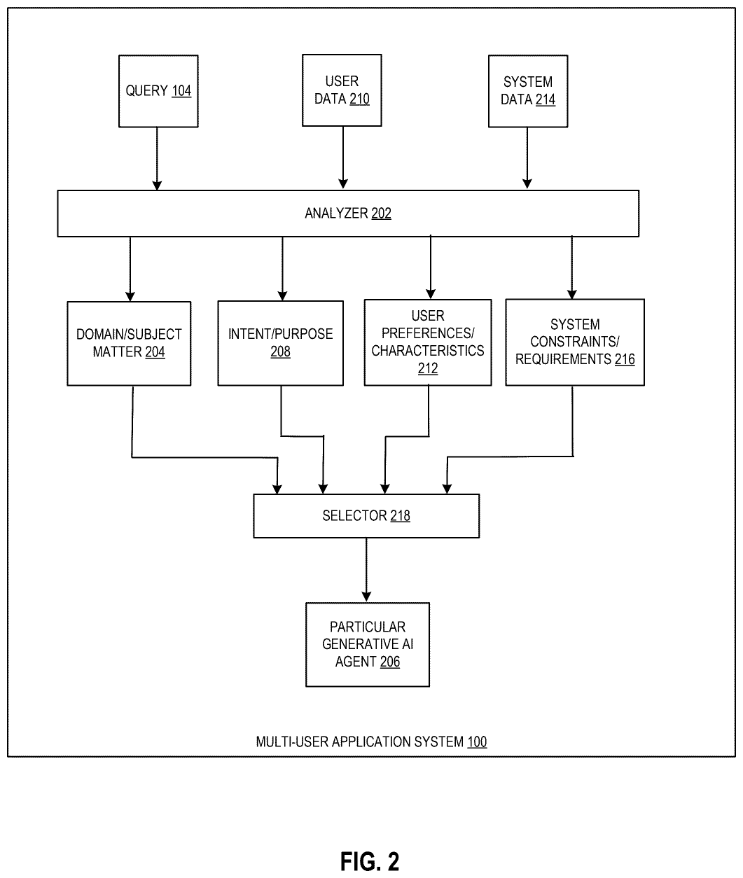

FIG. 2 illustrates an example extension of the system and method of FIG. 1 in which the selection of the particular generative AI agent can be made by the multi-user application system (100) in different ways, according to some embodiments of the present disclosure.

The selection process is based on analyzing various factors and using the analysis results to choose the most suitable AI agent for handling the query (104).

The selection process starts with receiving a selection of a particular generative AI agent from a set of one or more AI agents, where each agent is associated with an entity. FIG. 2 illustrates four alternative approaches for making this selection:

In one approach, an analyzer (202) of the multi-user application system (100) analyzes the query (104) to determine the domain or subject matter (204) associated with the query. Based on the identified domain or subject matter, the selector (218) selects the particular generative AI agent (206) that specializes in or is most relevant to that domain or subject matter.

In a second approach, the analyzer (202) analyzes the query (104) to determine the intent or purpose (208) behind the query, such as seeking information, requesting assistance, or performing a specific task. The selector (218) then selects the particular generative AI agent (206) that is best suited to fulfill the identified intent or purpose.

In a third approach, the analyzer (202) analyzes user data (210) associated with the client device (106) to determine user preferences or characteristics (212). These preferences or characteristics may include the user's interests, past interactions, or demographic information. The selection of the particular generative AI agent (206) is based on aligning with the user preferences or characteristics.

In a fourth approach, the analyzer (202) analyzes system data (214) associated with the multi-user application system (100) to determine system constraints or requirements (216), such as available resources, workload, or performance metrics. The selector (218) selects the particular generative AI agent (206) based on its ability to operate within the identified system constraints or requirements.

After the selection of the particular generative AI agent, the method proceeds with the steps described in FIG. 1. It receives a query from the client device, generates an embedding based on the query, retrieves query-relevant content from a knowledge database associated with the entity, determines the communication type associated with the entity, generates an LLM prompt incorporating the query-relevant content and instructions to apply the communication type, receives an LLM output from an LLM service, and returns a response to the query based on the LLM output.

The selection approach of FIG. 2 introduces the analyzer (202) and selector (218) components within the multi-user application system (100) to perform the selection of the generative AI agent. The analyzer (202) is responsible for analyzing the query (104), user data (210), or system data (214) to extract relevant information, while the selector (218) uses the analysis results to choose the most appropriate AI agent (206) for handling the query.

The different selection approaches allow for a more targeted and context-aware selection of the generative AI agent. By considering factors such as the query's domain or intent, user preferences, or system constraints, the method aims to select the AI agent that is best equipped to provide a relevant and effective response to the user's query.

In the first approach, the analyzer (202) of the multi-user application system (100) analyzes the query (104) to determine the domain or subject matter (204) associated with the query. The domain or subject matter refers to the specific area of knowledge or topic that the query pertains to.

For example, consider a query (104) that states: “What are the key features of a convolutional neural network (CNN)?” The analyzer (202) processes this query and uses techniques such as keyword extraction, named entity recognition, or text classification to identify that the query is related to the domain of deep learning or the subject matter of convolutional neural networks.

The analysis process may involve comparing the query text with a predefined set of domain or subject matter categories and their associated keywords or patterns. The analyzer (202) may employ machine learning models trained on labeled data to classify the query into one or more relevant domains or subject matters.

Once the domain or subject matter (204) is determined, the selector (218) uses this information to select the particular generative AI agent (206) that specializes in or is most knowledgeable about the identified domain or subject matter.

Continuing with the example, assume there are multiple generative AI agents available, each specializing in different areas of artificial intelligence. The selector (218) would then choose the AI agent that is specifically trained or has extensive knowledge in the field of deep learning or convolutional neural networks.

The selection process may involve matching the identified domain or subject matter (204) with the metadata or descriptions associated with each available AI agent. The selector (218) compares the domain or subject matter with the agent's capabilities, expertise, or training data to find the most suitable match.

In the second approach, the analyzer (202) of the multi-user application system (100) analyzes the query (104) to determine the intent or purpose (208) associated with the query. The intent or purpose refers to the underlying goal or objective that the user aims to achieve by making the query.

For example, consider a query (104) that states: “How can I book a flight from New York to London?” The analyzer (202) processes this query and employs techniques such as intent classification, semantic analysis, or pattern matching to identify that the intent behind the query is to make a flight reservation or booking.

The analysis process may involve comparing the query text with a predefined set of intent categories and their associated keywords, patterns, or linguistic structures. The analyzer (202) may utilize machine learning models, such as recurrent neural networks (RNNs) or transformer-based models, trained on labeled data to classify the query into one or more relevant intent categories.

Once the intent or purpose (208) is determined, the selector (218) uses this information to select the particular generative AI agent (206) that is best suited to fulfill the identified intent or purpose.

Continuing with the example, assume there are multiple generative AI agents available, each specializing in different tasks or functionalities. The selector (218) would then choose the AI agent that is specifically designed or trained to handle flight bookings or travel-related queries.

The selection process may involve matching the identified intent or purpose (208) with the capabilities or functionalities associated with each available AI agent. The selector (218) compares the intent or purpose with the agent's description, trained skills, or supported actions to find the most appropriate match.

In the third approach, the analyzer (202) of the multi-user application system (100) analyzes user data (210) associated with the client device (106) to determine user preferences or characteristics (212). User preferences or characteristics refer to the individual's interests, preferences, behaviors, or demographic information that can be used to personalize the selection of the generative AI agent.

For example, consider a scenario where the user data (210) includes information such as the user's age, gender, location, browsing history, past interactions with the system, and previously expressed interests or preferences. The analyzer (202) processes this user data and employs techniques such as data mining, pattern recognition, or user profiling to extract meaningful insights about the user's preferences or characteristics.

The analysis process may involve applying statistical analysis, machine learning algorithms, or rule-based systems to the user data (210) to identify significant patterns, correlations, or segments. The analyzer (202) may use clustering algorithms to group users with similar preferences or characteristics together or employ collaborative filtering techniques to infer user preferences based on similar users' behaviors.

Once the user preferences or characteristics (212) are determined, the selection of the particular generative AI agent (206) is based on aligning with those preferences or characteristics.

Continuing with the example, assume there are multiple generative AI agents available, each tailored to specific user segments or preferences. The selection process would involve matching the identified user preferences or characteristics (212) with the target audience or user profiles associated with each AI agent.

For instance, if the user data suggests that the user is a young adult interested in fashion and lifestyle topics, the selection process may choose an AI agent that is specifically designed to engage with that demographic and has knowledge and communication styles relevant to fashion and lifestyle domains.

The selection process may involve comparing the user preferences or characteristics (212) with the metadata, descriptions, or trained models associated with each available AI agent. The agent that best aligns with the user's profile or preferences is selected.

In the fourth approach, the analyzer (202) of the multi-user application system (100) analyzes system data (214) to determine system constraints or requirements (216). System constraints or requirements refer to the limitations, capabilities, or performance considerations of the multi-user application system (100) that can influence the selection of the generative AI agent.

For example, consider a scenario where the system data (214) includes information such as available computational resources, network bandwidth, storage capacity, or the current workload of the system. The analyzer (202) processes this system data and employs techniques such as resource monitoring, performance profiling, or capacity planning to identify the system constraints or requirements.

The analysis process may involve measuring and evaluating various system metrics, such as CPU utilization, memory usage, response times, or throughput. The analyzer (202) may use statistical analysis, time series forecasting, or machine learning models to predict future system performance or identify potential bottlenecks.

Once the system constraints or requirements (216) are determined, the selector (218) selects the particular generative AI agent (206) based on its ability to operate within those constraints or meet the identified requirements.

Continuing with the example, assume there are multiple generative AI agents available, each with different computational requirements, response times, or scalability characteristics. The selection process would involve evaluating the system constraints or requirements (216) against the resource needs, performance profiles, or service level agreements associated with each AI agent.

For instance, if the system data indicates that the multi-user application system (100) is currently experiencing high workload and limited computational resources, the selector (218) may choose an AI agent that is optimized for efficiency, has lower resource demands, or can handle a higher volume of requests within the given constraints.

The selection process may involve comparing the system constraints or requirements (216) with the technical specifications, performance benchmarks, or resource utilization data associated with each available AI agent. The agent that best fits within the system constraints and can deliver the required performance is selected.

The four approaches can be combined in various ways to make a comprehensive and informed selection of the generative AI agent. The multi-user application system (100) can utilize multiple approaches simultaneously or in a specific order to consider different factors and criteria when choosing the most suitable AI agent for handling a user's query.

One possible combination is to start with the first approach and then apply the second approach. In this case, the analyzer (202) first determines the domain or subject matter (204) associated with the query (104) using techniques such as keyword extraction or text classification. Based on the identified domain, the selector (218) narrows down the list of candidate AI agents to those specializing in that particular domain. Next, the analyzer (202) applies the second approach to determine the intent or purpose (208) behind the query, such as seeking information, requesting assistance, or performing a specific task. The selector (218) then chooses the AI agent that is best suited to fulfill the identified intent or purpose from the narrowed-down list of domain-specific agents.

Another combination could involve using the third approach in conjunction with the first or second approaches. In this scenario, the analyzer (202) analyzes user data (210) to determine user preferences or characteristics (212), such as age, gender, interests, or past interactions. The selector (218) then filters or ranks the available AI agents based on their alignment with the user's preferences or characteristics. Subsequently, the analyzer (202) applies the first or second approaches to determine the domain or intent of the query, respectively. The selector (218) makes the selection by considering both the user preferences and the query's domain or intent, choosing the AI agent that best matches the user's profile and can handle the specific query effectively.

A third combination could involve using the fourth approach as a preliminary step before applying other approaches. In this case, the analyzer (202) starts by analyzing system data (214) to determine system constraints or requirements (216), such as available resources, workload, or performance limitations. The selector (218) then filters out AI agents that do not meet the system constraints or cannot operate efficiently within the given requirements. From the remaining pool of AI agents, the selector (218) can then apply the first, second, or third approaches to further refine the selection based on the query's domain, intent, or user preferences, respectively.

Additionally, the multi-user application system (100) can assign different weights or priorities to each approach based on the specific use case or the system's goals. For example, if the system prioritizes user satisfaction and personalization, it may give higher weight to the third approach and consider user preferences as the primary factor in selecting the AI agent. On the other hand, if the system focuses on efficiency and resource optimization, it may prioritize the fourth approach and give more importance to system constraints when making the selection.

The combination of approaches can also be dynamic and adaptive based on the available data and the system's learning capabilities. The multi-user application system (100) can continuously monitor and collect data related to user interactions, system performance, and the effectiveness of the selected AI agents. By analyzing this data over time, the system can learn and adjust the combination of approaches to improve the selection process and optimize the overall performance and user experience.

In an embodiment, the method of FIG. 1 is expanded upon by providing specific ways in which the selection of the particular generative AI agent can be made by the user of the client device (106). Four alternative approaches for the user to choose or influence the selection of the AI agent are described below.

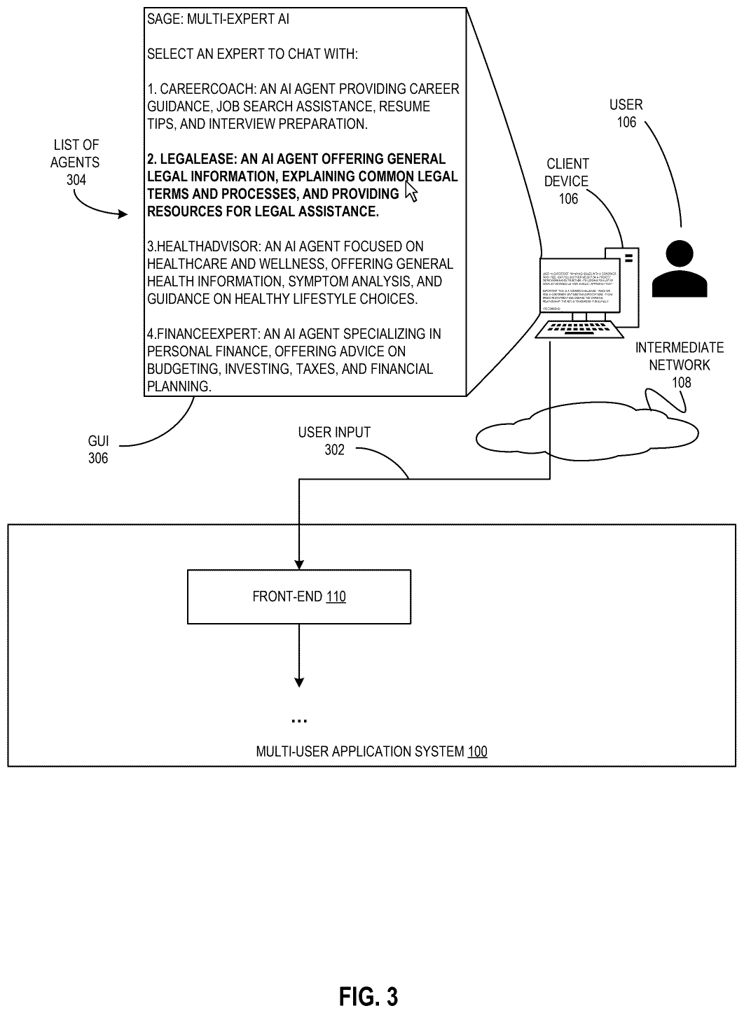

As illustrated in FIG. 3, the first approach involves the front-end (110) of the multi-user application system (100) receiving a direct user input 302 specifying the particular generative AI agent from a list of available options 304. The user is presented with a graphical user interface (GUI) 306 on the client device (106), displaying a list of AI agents 304 to choose from. The user can then explicitly select their preferred AI agent from this list.

The second approach involves the front-end (110) receiving user input specifying criteria for selecting the AI agent, such as a desired domain, subject matter, or communication style. Instead of directly selecting an AI agent, the user provides preferences or requirements for the agent. Based on these user-specified criteria, the multi-user application system (100) subsequently selects the AI agent that best matches the user's preferences.

The third approach involves the multi-user application system (100) accessing a user profile associated with the user, which is stored either on the client device (106) or within the system itself. This user profile contains information about the user's preferred generative AI agent or their preferences for selecting AI agents. The system uses this stored information to make the selection on behalf of the user.

The fourth approach involves the multi-user application system (100) processing the user interaction history associated with the user, which is stored either on the client device (106) or within the system. This interaction history includes data about the user's previous selections or preferences for generative AI agents. By analyzing this historical data, the system can infer the user's preferences and make the selection based on their past behavior.

These approaches provide different levels of user control and involvement in the selection process. The first approach gives the user direct control by allowing them to explicitly choose the AI agent. The second approach allows the user to specify criteria, but the selection is made by the system based on those criteria. The third and fourth approaches rely on stored user data, either in the form of a user profile or interaction history, to make the selection without explicit user input.

After the selection of the particular generative AI agent, the method proceeds with the meth of FIG. 1. It receives a query from the client device, generates an embedding based on the query, retrieves query-relevant content from a knowledge database associated with the entity, determines the communication type associated with the entity, generates an LLM prompt incorporating the query-relevant content and instructions to apply the communication type, receives an LLM output from an LLM service, and returns a response to the query based on the LLM output.

In the second approach, the user provides input specifying criteria for selecting the generative AI agent. The user's input includes preferences or requirements related to the desired domain, subject matter, or communication style of the AI agent. The multi-user application system (100) then uses these user-specified criteria to select the most appropriate AI agent.

For example, consider where the user wants to interact with an AI agent knowledgeable about personal finance and prefers a more formal communication style. The user accesses the multi-user application system (100) through the client device (106) and is presented with an interface to specify their criteria.

The front-end (110) of the system receives the user's input, which may be provided through various means such as dropdown menus, checkboxes, or text fields. In this case, the user selects “Personal Finance” as the desired domain and “Formal” as the preferred communication style.

Upon receiving the user's input, the multi-user application system (100) processes the specified criteria and matches them against the available generative AI agents. The system maintains a database or registry of AI agents, each associated with specific domains, subject matters, and communication styles.

The system (100)'s selection mechanism, implemented by a selector component, compares the user-specified criteria with the attributes of each AI agent. It looks for agents that specialize in the “Personal Finance” domain and have a “Formal” communication style. The selector may use techniques such as keyword matching, semantic similarity, or rule-based reasoning to determine the best match.

In this example, the selector identifies an AI agent called “FinanceExpert” as the best match for the user's criteria. FinanceExpert is an AI agent that specializes in personal finance topics and employs a formal communication style in its interactions.

The selector then assigns FinanceExpert as the particular generative AI agent for the user's session. The user's subsequent queries and interactions will be directed to FinanceExpert, which will provide responses and assistance related to personal finance matters.

By allowing the user to specify criteria for selecting the AI agent, the multi-user application system (100) offers a flexible and customizable approach. The user can express their preferences and requirements, and the system intelligently matches them with the most suitable AI agent.

In the third approach, the multi-user application system (100) accesses a user profile associated with the user to determine the preferred generative AI agent or the user's preferences for selecting AI agents. The user profile is stored either on the client device (106) or within the multi-user application system (100) itself.

For example, consider a scenario where a user frequently interacts with the multi-user application system (100) and has previously established a user profile. The user profile contains information about the user's preferred AI agents, domains of interest, communication style preferences, or other relevant details.

When the user initiates a new session or interacts with the system, the multi-user application system (100) retrieves the user profile associated with the user. This can be done by using user authentication mechanisms, such as login credentials or session tokens, to identify the user and locate their corresponding profile.

The user profile may be stored in a database or a file system, either locally on the client device (106) or remotely on the servers of the multi-user application system (100). The system's data access component, such as a profile manager or database connector, retrieves the user profile based on the user's identification.

Once the user profile is obtained, the multi-user application system (100) extracts the relevant information related to the user's AI agent preferences. This information may include the user's preferred generative AI agent, which they have explicitly selected or frequently interacted with in previous sessions. For example, the user profile may indicate that the user has a preference for an AI agent named “TechWhiz” that specializes in technology-related topics.

Alternatively, the user profile may contain more granular preferences, such as the user's preferred domains of interest (e.g., technology, sports, music) or communication styles (e.g., casual, informative, witty). These preferences can be used by the system's selection mechanism, implemented by the selector (218) component, to choose an AI agent that aligns with the user's preferences.

Based on the information retrieved from the user profile, the selector identifies the most suitable generative AI agent for the user's current session. If the user has a preferred AI agent explicitly specified in their profile, such as “TechWhiz,” the selector assigns that agent for the user's interactions. If the user profile contains preferences rather than a specific agent, the selector matches those preferences against the available AI agents and chooses the one that best fits the user's preferences.

By utilizing the user profile, the multi-user application system (100) can provide a personalized and seamless experience for the user. The user's preferences are automatically considered, and the most relevant AI agent is selected without requiring the user to make an explicit choice or provide input each time they interact with the system.

In the fourth approach, the multi-user application system (100) processes the user interaction history associated with the user to determine their previous selections or preferences for generative AI agents. The user interaction history is stored either on the client device (106) or within the multi-user application system (100).

For example, consider where a user has been interacting with the multi-user application system (100) over a period of time. During their interactions, the user has engaged with multiple generative AI agents, each specializing in different domains or topics.

The multi-user application system (100) captures and stores the user's interaction history, which includes information such as the AI agents the user has interacted with, the queries they have made, the duration of their interactions, and any feedback or ratings provided by the user. This interaction history may be stored in a database or log files, either locally on the client device (106) or on the servers of the multi-user application system (100).

When the user initiates a new session or interacts with the system, the multi-user application system (100) retrieves the user interaction history associated with the user. Similar to the user profile approach, the system uses user identification mechanisms to locate and access the relevant interaction history.

Once the user interaction history is obtained, the multi-user application system (100) processes and analyzes the data to identify patterns, preferences, and previous selections made by the user. The system's data analysis component, such as a recommendation engine or machine learning model, examines the interaction history to extract meaningful insights.

The analysis may involve various techniques, such as frequency analysis, collaborative filtering, or sequence mining, to identify the user's preferred AI agents or domains of interest. For example, the analysis may reveal that the user frequently interacts with an AI agent named “HealthAdvisor” and has a high engagement rate with health-related topics.

Based on the insights derived from the user interaction history, the multi-user application system (100) infers the user's preferences and makes a selection of the generative AI agent. The system's selection mechanism, implemented by the selector component, uses the historical data to determine the most suitable AI agent for the user's current session.

In this example, if the user interaction history indicates a strong preference for the “HealthAdvisor” AI agent and health-related topics, the selector assigns HealthAdvisor as the generative AI agent for the user's interactions. The system may also consider factors such as the recency and frequency of interactions to give more weight to the user's most recent preferences.

By leveraging the user interaction history, the multi-user application system (100) can make data-driven decisions and provide a personalized experience for the user. The system learns from the user's past behavior and adapts the selection of the generative AI agent accordingly, without requiring explicit input from the user.

The different approaches can be combined in various ways to make a comprehensive and informed selection of the generative AI agent. The multi-user application system (100) can leverage multiple approaches simultaneously or in a specific order to consider different factors and criteria when choosing the most suitable AI agent for the user.

One possible combination is to prioritize the user's explicit input (approach 1 or 2) while falling back to the user profile (approach 3) or interaction history (approach 4) when explicit input is not available. In this scenario, the system first checks if the user has directly selected an AI agent from the list of available options or provided specific criteria for selection. If the user has made an explicit choice, the system honors that choice and assigns the selected AI agent for the user's interactions.

However, if the user has not provided explicit input, the system then looks for information in the user profile or interaction history to make an informed selection. It retrieves the user profile and checks if the user has a preferred AI agent or domain preferences stored. If such preferences exist, the system selects the AI agent that aligns with the user's stored preferences.

If the user profile does not contain sufficient information, the system moves on to analyzing the user interaction history. It processes the historical data to identify patterns, frequently interacted agents, or domains of interest. Based on the insights derived from the interaction history, the system selects the AI agent that best matches the user's inferred preferences.

Another combination approach is to use the user profile (approach 3) as the primary source of information while incorporating the user interaction history (approach 4) to refine or update the preferences stored in the profile. In this case, the system first retrieves the user profile and checks for any explicitly stated preferences or preferred AI agents. If found, the system selects the AI agent based on the profile information.

However, the system also analyzes the user interaction history to validate and update the preferences stored in the user profile. It looks for any discrepancies or changes in the user's behavior or interests over time. If the interaction history suggests a shift in preferences or a new frequently interacted AI agent, the system updates the user profile accordingly and selects the AI agent based on the updated preferences.

A third combination approach is to use the user interaction history (approach 4) as the primary source of information while allowing the user to override the system's selection through explicit input (approach 1 or 2). In this scenario, the system starts by analyzing the user interaction history to identify the user's preferences and frequently interacted AI agents. Based on this analysis, the system selects the most appropriate AI agent for the user's interactions.

However, the system also provides an option for the user to explicitly select an AI agent or provide specific criteria for selection. If the user chooses to make an explicit selection, the system prioritizes the user's input over the interaction history-based selection. This allows the user to have control and flexibility in cases where their current preferences differ from their historical behavior.

Additionally, the system can assign different weights or priorities to each approach based on factors such as the reliability of the information source, the recency of the data, or the system's confidence in the inferred preferences. For example, the system may give higher priority to explicit user input, followed by the user profile, and then the interaction history.

The specific combination of approaches used by the multi-user application system (100) can be determined based on the available data, the system's design goals, and the desired balance between user control and system automation. The system can also incorporate machine learning algorithms to continuously learn and adapt the selection process based on user feedback and ongoing interactions.

By combining different approaches, the multi-user application system (100) can make a more robust and personalized selection of the generative AI agent, taking into account explicit user preferences, stored user profiles, and historical interaction data to provide the most relevant and tailored experience for the user.

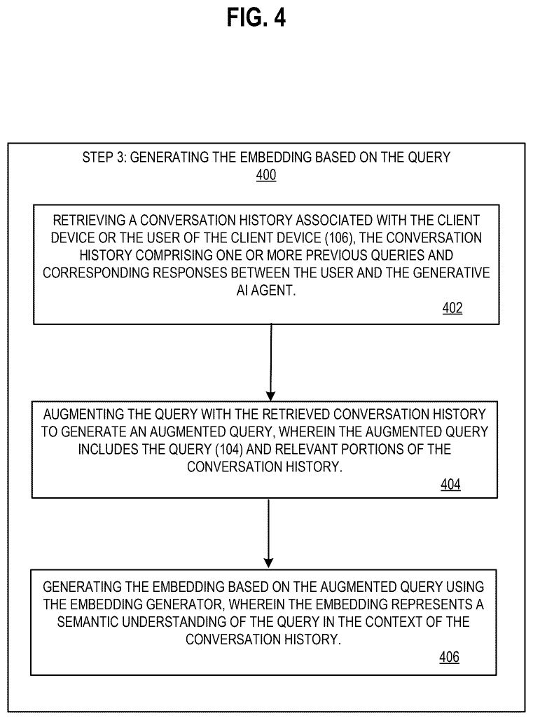

FIG. 4 illustrates an extension to the method of FIG. 1 providing a specific way of generating the embedding based on the query, according to an embodiment of the present disclosure. It introduces the concept of using conversation history to augment the query before generating the embedding, which helps in capturing the context and semantic understanding of the query within the ongoing conversation.

The method of FIG. 1 involves generating an embedding based on the received query. The method (400) of FIG. 4 builds upon this step by introducing a mechanism to retrieve and utilize the conversation history associated with the client device (106) or the user of the client device (106). The conversation history includes the previous queries and corresponding responses exchanged between the user and the generative AI agent.

The method (400) starts by retrieving (402) the relevant conversation history. This history provides valuable context and helps in understanding the current query in relation to the previous interactions. By considering the conversation history, the system (100) can generate an embedding that captures the semantic meaning of the query within the context of the ongoing dialogue.

After retrieving the conversation history, the method (400) proceeds to augment (404) the current query (104) with the relevant portions of the conversation history. This augmentation process involves combining the current query with the historical context, creating an augmented query that includes both the current query and the relevant parts of the conversation history.

The augmented query serves as a more comprehensive representation of the user's intent and the context in which the query is being asked. It allows the system to consider the previous interactions and the flow of the conversation when generating the embedding.

Next, the embedding generator (112) takes the augmented query as input and generates (406) an embedding based on it. The embedding represents a semantic understanding of the query (104) within the context of the conversation history. By incorporating the conversation history into the embedding generation process, the system (100) can capture the nuances, dependencies, and contextual information that are relevant to the current query.

The generated embedding is then used in the subsequent steps of the method of FIG. 1, to retrieve query-relevant content from the knowledge database associated with the entity. The retrieved content, along with the determined communication type, is used to generate an LLM prompt. The LLM service processes the prompt and generates an output, which is then returned as the response to the user's query.

By incorporating the conversation history in the embedding generation process, the method (400) enhances the method of FIG. 1 by providing a more contextualized and semantically meaningful representation of the query. It allows the system (100) to consider the previous interactions and the flow of the conversation when generating the response, leading to more coherent and relevant answers.

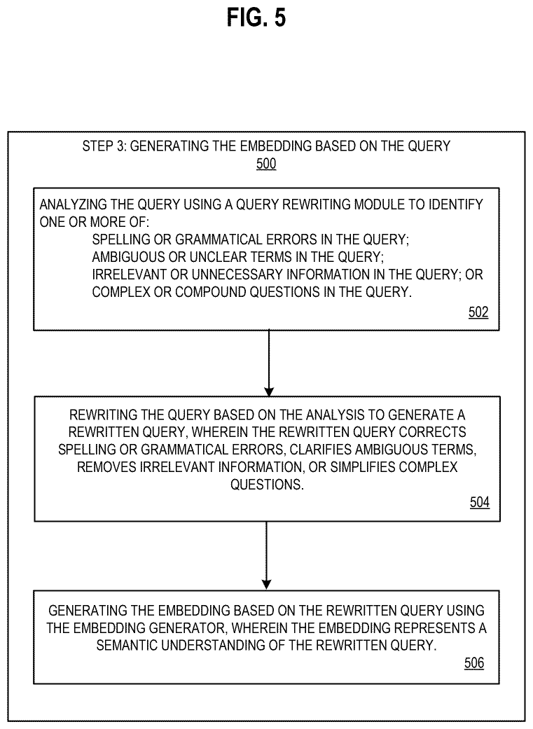

FIG. 5 illustrates a method 500 that extends the method of FIG. 1 by providing a specific way of generating the embedding based on the query, according to some embodiments of the present disclosure. It introduces the concept of query rewriting, which involves analyzing and modifying the query before generating the embedding. The purpose of query rewriting is to improve the clarity, relevance, and simplicity of the query, thereby enhancing the accuracy and effectiveness of the generated embedding.

In the method of FIG. 1, the method involves generating an embedding based on the received query. The method 500 of FIG. 5 builds upon this step by introducing a query rewriting module that analyzes the query (104) to identify potential issues or areas for improvement. The query rewriting module focuses on four specific aspects:

Spelling or grammatical errors in the query (104): The module checks for any misspellings or grammatical mistakes that may hinder the understanding or interpretation of the query.

Ambiguous or unclear terms in the query (104): The module identifies terms or phrases that may have multiple meanings or lack clarity, making it difficult to accurately understand the user's intent.

Irrelevant or unnecessary information in the query (104): The module detects any extraneous or unrelated information that does not contribute to the core meaning or purpose of the query.

Complex or compound questions in the query (104): The module identifies queries that contain multiple sub-questions or complex structures, which may require simplification or decomposition for better processing.

After analyzing the query, the query rewriting module generates a rewritten query based on the identified issues. The rewriting process involves any or all of the following actions:

Correcting spelling or grammatical errors to ensure the query is free from mistakes that may affect its interpretation.

Clarifying ambiguous terms by replacing them with more specific or well-defined alternatives, improving the precision of the query.

Removing irrelevant or unnecessary information to focus on the core intent of the query and reduce noise.

Simplifying complex or compound questions by breaking them down into simpler sub-queries or rephrasing them for better comprehension.

The rewritten query serves as a cleaner, clearer, and more focused representation of the user's intent. By addressing the identified issues, the rewritten query aims to improve the quality and relevance of the subsequent embedding generation process.

Next, the embedding generator (112) takes the rewritten query as input and generates an embedding based on it. The embedding represents a semantic understanding of the rewritten query, capturing its meaning and context in a dense vector representation.

The generated embedding is then used in the subsequent steps of the method, as described in the method of FIG. 1, to retrieve query-relevant content from the knowledge database associated with the entity. The retrieved content, along with the determined communication type, is used to generate an LLM prompt. The LLM service processes the prompt and generates an output, which is then returned as the response to the user's query.

By incorporating query rewriting in the embedding generation process, the method 500 enhances the method of FIG. 1 by improving the quality and clarity of the query before generating the embedding. It helps in addressing potential issues or ambiguities in the query, leading to a more accurate and relevant semantic representation.

In an embodiment, the method of FIG. 1 is extended by providing specific details about the communication type associated with the entity. It defines the communication type as a conversational tone or style and specifies various attributes or dimensions that characterize the tone or style.

In FIG. 1, the method involves determining a communication type associated with the entity. The communication type represents the way in which the entity communicates or interacts with users.

In an embodiment, the communication type indicates a conversational tone or style specific to the entity. The conversational tone or style refers to the manner, approach, or characteristics of the entity's communication in the context of a conversation.

In an embodiment, any or all of the following different attributes or dimensions are used to describe or categorize the conversational tone or style:

Formal or informal tone: This attribute indicates whether the entity's communication style is characterized by adherence to formal language, proper grammar, and professional etiquette (formal tone) or a more casual, relaxed, and colloquial approach (informal tone).

Friendly or professional tone: This attribute distinguishes between a warm, approachable, and personable communication style (friendly tone) and a more detached, businesslike, and task-oriented approach (professional tone).

Humorous or serious tone: This attribute reflects whether the entity's communication incorporates elements of humor, wit, or lightheartedness (humorous tone) or maintains a solemn, straightforward, and matter-of-fact demeanor (serious tone).

Concise or elaborate style: This attribute indicates whether the entity's communication is characterized by brevity, succinctness, and a focus on key points (concise style) or a more detailed, descriptive, and expansive approach (elaborate style).

Direct or indirect style: This attribute distinguishes between a straightforward, explicit, and unambiguous communication approach (direct style) and a more subtle, implicit, and nuanced manner of conveying information (indirect style).

Empathetic or neutral tone: This attribute reflects whether the entity's communication demonstrates understanding, compassion, and emotional connection (empathetic tone) or maintains an impartial, objective, and unbiased stance (neutral tone).

Persuasive or informative tone: This attribute indicates whether the entity's communication aims to influence, convince, or motivate the user (persuasive tone) or focuses on providing factual, educational, and knowledge-based content (informative tone).

These attributes provide a framework for characterizing the communication type associated with the entity. They help in defining the tone, style, and approach that the entity adopts when engaging in conversations with users.

In the context of the method of FIG. 1, the determined communication type, along with the query-relevant content, is used to generate an LLM prompt. The LLM prompt includes instructions to apply the specified communication type to the LLM output. By incorporating the communication type in the prompt, the LLM service can generate responses that align with the entity's conversational tone or style.

In an embodiment, an extension of the method of FIG. 1 provides specific details about the process of generating the LLM prompt. The extensions involves analyzing the communication type, generating instructions based on the communication attributes, and constructing the LLM prompt that guides the LLM service to generate output in accordance with the entity's communication style.

In FIG. 1, the method involves generating an LLM prompt that comprises the query-relevant content and instructions to apply the communication type to the LLM output. The extension involves a three-part process for generating the LLM prompt:
Part 1: Analyzing the communication type:

The method starts by analyzing the communication type associated with the entity to identify one or more communication attributes. Communication attributes refer to the specific characteristics or qualities that define the entity's communication style. These attributes may include aspects such as tone, formality, persuasiveness, empathy, or any other relevant dimensions that describe how the entity communicates.
Part 2: Generating instructions based on communication attributes:

Based on the identified communication attributes, the method generates instructions that guide the LLM service (122) to generate output in accordance with the entity's communication style. These instructions serve as a set of rules, guidelines, or parameters that inform the LLM service about the desired characteristics of the generated output. The instructions may specify the tone to be used, the level of formality to be maintained, the persuasive techniques to be employed, or any other relevant aspects that align with the entity's communication style.
Part 3: Constructing the LLM prompt:

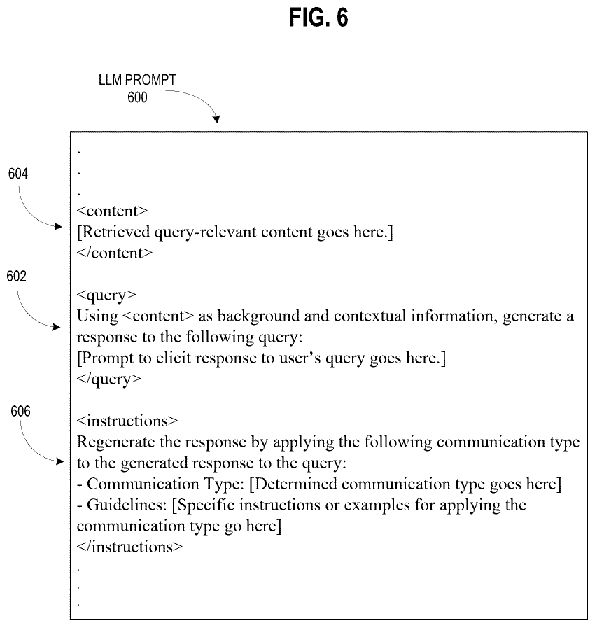

As illustrated in FIG. 6, the LLM prompt 600 is constructed by combining three components.

The first component (602) is the query (104) or a rewritten or augmented version of the query (104). This component represents the user's original query or a modified version of it. The query may be rewritten to improve clarity, remove ambiguity, or simplify complex questions. It may also be augmented with additional context or information to provide a more comprehensive understanding of the user's intent.

The second component (604) is the query-relevant content retrieved from the knowledge database (116). This component includes the information or knowledge that is relevant to the user's query. It is retrieved from the knowledge database associated with the entity using the generated embedding. The query-relevant content serves as the factual basis or context for generating the LLM output.

The third component (606) is the generated instructions for applying the communication type to LLM output. This component incorporates the instructions generated based on the communication attributes. It guides the LLM service to generate output that aligns with the entity's communication style. The instructions ensure that the generated output reflects the desired tone, formality, persuasiveness, or other relevant aspects of the entity's communication.

By constructing the LLM prompt in this manner, the method aims to provide the LLM service (122) with the necessary information and guidelines to generate output that is relevant to the user's query, based on the retrieved knowledge, and in accordance with the entity's specific communication style. In the context of the method of FIG. 1, the generated LLM prompt is submitted to the LLM service (122), which processes the prompt and generates the particular LLM output. The LLM output is then used to formulate the response that is returned to the user's query.

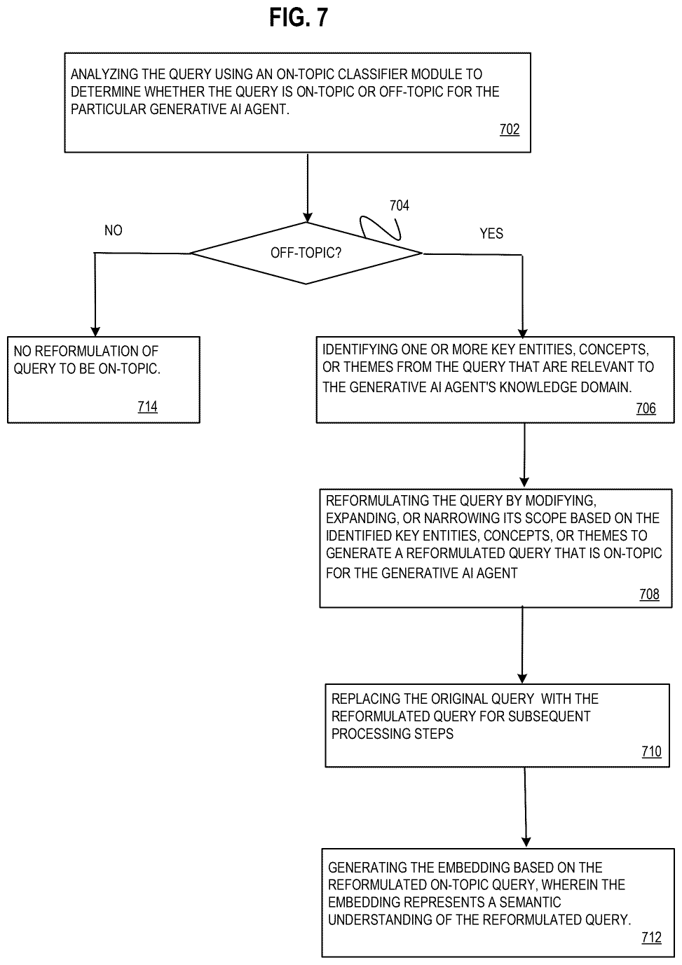

FIG. 7 illustrates an extension to the method of FIG. 1. The extension introduces an additional step that occurs before generating the embedding based on the query. This step involves analyzing the query to determine if it is on-topic or off-topic for the particular generative AI agent and reformulating the query if it is found to be off-topic. The reformulated query is then used as the basis for generating the embedding.

In method of FIG. 1, the method assumes that the received query is relevant and appropriate for the selected generative AI agent. It proceeds to generate an embedding based on the query without any prior analysis or modification of the query.

The method 700 of FIG. 7 adds a preprocessing step that aims to ensure the query is on-topic and aligned with the generative AI agent's knowledge domain before generating the embedding. The process involves several sub-steps:

Analyzing the query using an on-topic classifier module:

The method 700 starts by analyzing (702) the query (104) using an on-topic classifier module. The on-topic classifier module is a component that assesses whether the query is relevant to the generative AI agent's knowledge domain. It uses techniques such as text classification, topic modeling, or semantic similarity to determine if the query is on-topic or off-topic.

Handling off-topic queries:

If the query (104) is determined (704) to be off-topic by the on-topic classifier module, the method proceeds to reformulate the query. The reformulation process involves identifying (706) key entities, concepts, or themes from the query that are relevant to the generative AI agent's knowledge domain. These key elements serve as the basis for modifying, expanding, or narrowing (708) the scope of the query to make it more aligned with the AI agent's expertise. The goal is to generate a reformulated query that is on-topic and falls within the generative AI agent's knowledge domain.

Replacing the original query with the reformulated query:

After generating the reformulated query, the method 700 replaces (710) the original query with the reformulated version. The reformulated query becomes the new input for the subsequent processing steps, including generating the embedding.

Generating the embedding based on the reformulated query:

The method (700) proceeds to generate (712) the embedding based on the reformulated on-topic query. The embedding represents a semantic understanding of the reformulated query, capturing its meaning and context. By using the reformulated query, the embedding is more likely to be relevant and aligned with the generative AI agent's knowledge domain.

The subsequent steps of the method of FIG. 1 remain the same. The generated embedding is used to retrieve query-relevant content from the knowledge database associated with the entity. The retrieved content, along with the determined communication type, is used to generate an LLM prompt. The LLM service processes the prompt and generates the particular LLM output, which is then used to formulate the response to the user's query.

The method 700 highlights the importance of ensuring that the user's query is on-topic and relevant to the generative AI agent's knowledge domain. By introducing a preprocessing step to analyze and reformulate off-topic queries, the method aims to improve the quality and relevance of the generated embeddings and subsequent responses.

When the query is determined (704) to be on-topic by the on-topic classifier module, the method 700 proceeds with the method of FIG. 1 without (714) any modification or reformulation of the query to be on-topic.

The process starts with the received query (104) being analyzed by the on-topic classifier module. The classifier module employs techniques such as text classification, topic modeling, or semantic similarity to assess the relevance of the query to the generative AI agent's knowledge domain.

If the query is deemed on-topic, it means that the query falls within the scope of the AI agent's expertise and is likely to be answerable based on the knowledge available to the agent. In this case, the method proceeds directly to the next step, which is generating the embedding based on the original query (104).

The embedding generation process takes the on-topic query as input and applies techniques such as word embeddings, sentence embeddings, or transformer-based models to create a dense vector representation of the query. The embedding captures the semantic meaning and context of the query in a numerical format that can be efficiently processed by the system.

Once the embedding is generated, the method uses it to retrieve query-relevant content from the knowledge database associated with the entity. The knowledge database stores a collection of content, such as documents, articles, or other relevant information, that is specific to the entity and its domain.

The retrieval process involves comparing the generated embedding with the embeddings or representations of the content stored in the knowledge database. Similarity metrics, such as cosine similarity or Euclidean distance, are used to measure the relevance of each content item to the query. The most relevant content is selected based on the similarity scores.

After retrieving the query-relevant content, the method determines the communication type associated with the entity. The communication type represents the preferred style, tone, or manner in which the entity communicates with users. It can include attributes such as formality, empathy, persuasiveness, or other characteristics that define the entity's communication style.

The retrieved content and the determined communication type are then used to generate an LLM prompt. The LLM prompt is a structured input that combines the query, the relevant content, and instructions on how to apply the communication type to the generated output. It serves as a guide for the LLM service to generate a response that is informative, relevant, and aligned with the entity's communication style.

The LLM prompt is submitted to the LLM service, which processes the prompt and generates the particular LLM output. The LLM service utilizes its pre-trained language model to generate a coherent and contextually appropriate response based on the provided prompt.

The generated LLM output is used to formulate the response to the user's query. The response is returned to the user via the client device, providing the requested information or assistance in a manner that is consistent with the entity's communication style.

By following these steps when the query is on-topic, the method (700) ensures that the generative AI agent can efficiently process the query, retrieve relevant content, and generate a meaningful response that aligns with the entity's knowledge domain and communication preferences. The on-topic query allows the AI agent to leverage its expertise effectively and provide accurate and helpful information to the user.

### Example Large Language Model (LLM) Architecture

A Large Language Model (LLM) is a neural network architecture, which may be based on the Transformer framework, designed for advanced natural language processing tasks. At its core, an LLM may begin with a tokenization process, employing algorithms like Byte Pair Encoding or WordPiece to break down input text into subword units. These tokens are then transformed into high-dimensional vector representations called embeddings, which capture semantic relationships between words.

The model's architecture may be centered around multi-head self-attention mechanisms, which allow it to analyze relationships between all tokens in a sequence, facilitating the capture of long-range dependencies. This may be complemented by feed-forward neural networks, layer normalization, and residual connections. The self-attention layers may enable the model to focus on different parts of the input when processing each token, while the feed-forward networks further transform these representations.

LLMs may be pre-trained on massive datasets, learning general linguistic patterns and world knowledge. This pre-training phase may involve objectives like masked language modeling or next-token prediction. The models may then be fine-tuned for specific tasks through transfer learning.

The architecture's scale may be a defining feature, with models often containing billions of parameters. This vast parameter count, combined with sophisticated input representations and efficient training techniques, may enable LLMs to capture intricate language patterns and generate coherent, contextually relevant text across various domains. The output may be produced through a layer that generates probability distributions over the vocabulary, with decoding techniques like beam search or nucleus sampling may be used to produce the text output.

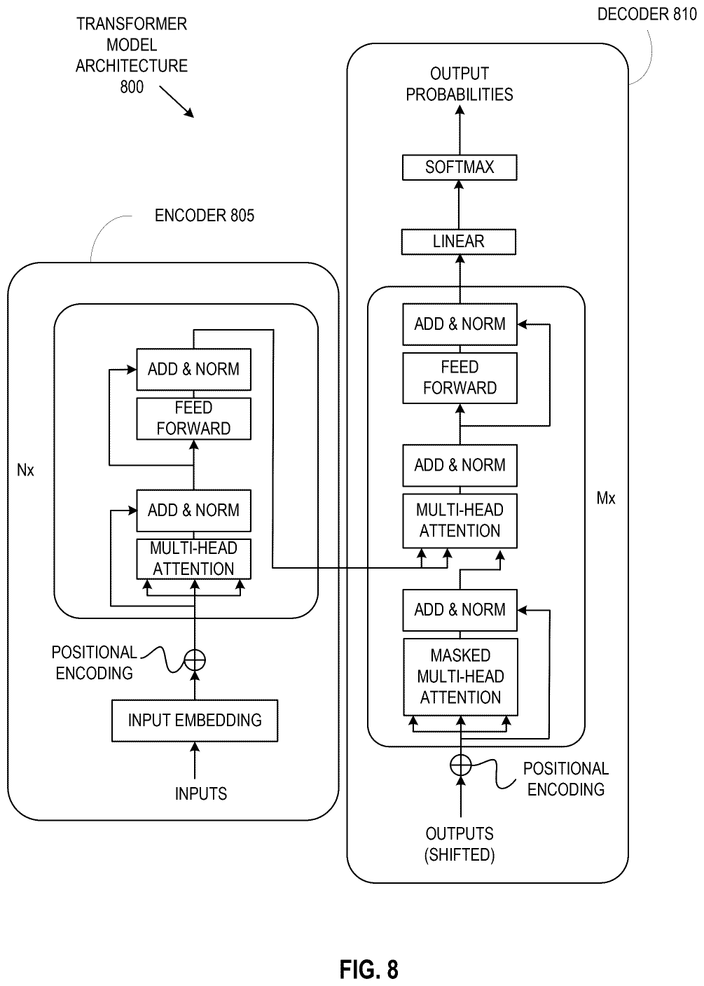

FIG. 8 illustrates an example Transformer model architecture 800 that may be used in an implementation of the LLLM of the LLM service (122), according to some embodiments of the present disclosure.

The Transformer model architecture 800 may be a neural network design for natural language processing. At its core, the Transformer 800 may encompass an encoder 805 and a decoder 810, both leveraging self-attention mechanisms. The architecture 800 may begin with an input embedding layer that converts tokens into high-dimensional vector representations, which may range, for example, from 128 to 1024 dimensions. These embeddings may be augmented with positional encodings to retain sequence order information.

The Transformer 800 may include a multi-head self-attention mechanism. This may allow the model 800 to simultaneously attend to different parts of the input sequence, capturing various types of relationships and dependencies. Each attention head may compute query, key, and value vectors, enabling the model to focus on relevant parts of the input when processing each token. Following the attention layers, the architecture 800 may incorporate feed-forward neural networks with multiple layers and non-linear activation functions.

A masked multi-head attention mechanism in the decoder 810 of a Transformer model 800 may be designed to prevent the model from attending to future tokens during sequence generation. In this mechanism, multiple attention heads may operate in parallel, each computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting all upper triangular elements to negative infinity. This masking may ensure that each position can only attend to previous positions in the sequence, maintaining the autoregressive property of the decoder. The masked attention scores may then be used to compute a weighted sum of the value vectors. The outputs from all heads may be concatenated and linearly transformed to produce the attention output. This process may allow the decoder to generate tokens sequentially while considering only the previously generated tokens, thus preserving the causal nature of language modeling.

To maintain stable training and mitigate vanishing gradients, the Transformer 800 may employ layer normalization after each sub-layer (self-attention and feed-forward networks) and may introduce residual connections. These residual connections may allow unimpeded information flow through the network. The model may consist of multiple such encoder and decoder layers stacked on top of each other, increasing its capacity to learn complex language patterns.

The output layer may involve a linear transformation followed by a softmax function, producing probability distributions over the vocabulary for text generation tasks. This architecture 800's design may allow for efficient parallel processing of input sequences, making it particularly suitable for handling the extensive datasets used in training LLMs.

### Example Multi-User Application System

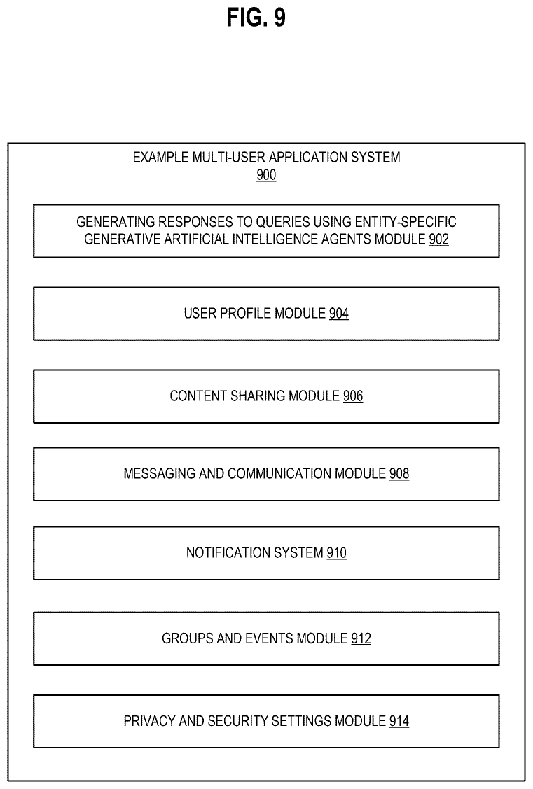

FIG. 9 illustrates an example multi-user application system 900 in which the techniques disclosed herein for generating responses to queries using entity-specific generative artificial intelligence agents are implemented, according to some embodiments of the present disclosure.

Example multi-user application system 900 is implemented at least in part by one or more programmable electronic devices (e.g., example programmable electronic device 1000 of FIG. 1000) located or housed in one or more data centers or other physical computer hosting facilities. Example multi-user application system 900 is connected to a data communications network, such as the internet, to interact with (e.g., exchange data with) the programmable electronic devices of users (e.g., smartphones, laptop computers, desktop computers, tablet computers, or other electronic personal computing devices).

Example multi-user application system 900 is an online service, platform, or site that focuses on facilitating the building of social, professional, organizational, community, or governmental networks or relations among people, business, organizations, governments, communities, groups, or other entities (generally “users”). A “member” is a user that uses, interacts, or accesses the example multi-user application system 900 under an established identity such as an identity established via a user authentication process. For example, a member can be a registered user of the example multi-user application system 900 with a verified account that allows the member to access, use, or interact with access-controlled features of the example multi-user application system 900 that are not available to non-member users. For example, in a social networking context, such access-controlled features may include the ability for a member to post, comment, and interact with other members under a recognized identity. Whereas a non-member user may have only limited access such the ability to view member profiles but not the ability to message or connect or other interact with a member.

Example multi-user application system 900 allows members to connect with other members based on shared interests, backgrounds, real-life connections, or activities. Members create personal profiles where they post various types of content, such as text, photos, and videos, and engage with others through features like messaging, commenting, and liking.

Example multi-user application system 900 offers a digital space for members to share their experiences, ideas, and thoughts, fostering communication and interaction across diverse communities. In an embodiment, example multi-user application system 900 offers additional functionalities, such as creating groups, organizing events, and discovering content based on member preferences.

Example multi-user application system 900 is composed of various modules and components, each serving a distinct function to enhance member experience and interaction. One module of example multi-user application system 900 is the generating responses to queries using entity-specific generative artificial intelligence agents module 902 configured to perform or implement the techniques disclosed herein for generating responses to queries using entity-specific generative artificial intelligence agents. In addition to generating responses to queries using entity-specific generative artificial intelligence agents module 902, example multi-user application system 900 includes any or all of the following modules: member profile module 904, content sharing module 906, messaging and communication module 908, notification system 910, groups and events module 912, privacy and security settings module 914, or any other suitable multi-user application system module.

Member profile module 904 allows members to create and manage their personal profiles, providing information about themselves and their interests. The member profile module 904 provides a personal space for members to represent themselves and manage their presence on the platform. This member profile module 904 allows members to create and customize their profiles, which act as their digital identity within the network. In an embodiment, the customization includes adding personal information such as name, profile picture, cover photo, logo, avatar, or a bio that reflects their identity, personality, or interests. In an embodiment, members also share additional details like their location, education, work history, and interests, helping to paint a more comprehensive picture of who they are.

Besides personal information, the member profile module 904 enables members to showcase their activities and content on the platform. This includes a timeline or feed of their posts, photos, videos, and shared content, providing a chronological overview of their activity. Members manage the visibility of these elements, controlling who can see their posts and personal information through privacy settings integrated within the member profile module 904.

Additionally, the member profile serves as a hub for social interactions. It allows others to view the member's information, connect by sending friend requests or follows, and engage with the member's content through likes, comments, and shares. In an embodiment, member profile module 904 also includes features like badges or indicators of achievements and activities, further enriching the member's profile.

The content sharing module 906 allows members to post, share, and interact with various types of content like text, images, and videos. This content sharing module 906 provides the ability for members to upload different types of media, such as text posts, photos, videos, and links to external content. This content sharing module 906 includes member-friendly interfaces for creating and editing posts, with, in an embodiment, tools for adding filters to photos, editing video clips, or formatting text. Once content is shared, it becomes visible to others within the member's network, depending on the member's privacy settings.

Content sharing module 906 also facilitates interaction with this content, allowing viewers to like, comment, and share posts, thus promoting engagement and discussion. In an embodiment, advanced features include tagging other members, adding location data, or incorporating hashtags to categorize content and increase its visibility. Content sharing module 906 integrates with the system 900's algorithms to display content in members' feeds based on relevance, recency, and personal preferences. In an embodiment, module 906 provided analytics to members, especially content creators or businesses, offering insights into the reach and engagement of their posts.

The messaging and communication module 908 facilitates private and group conversations, enabling direct and instant communication among members. This messaging and communication module 908 offers a range of functionalities that support both private and group messaging. For private messaging, members send and receive text messages, photos, videos, and links in a one-on-one setting, similar to a traditional Short Message Service (SMS) but with enhanced multimedia capabilities. In an embodiment, this private messaging supports features like read receipts, typing indicators, and the ability to send voice messages. In addition to private conversations, the messaging and communication module 908 includes group messaging capabilities, allowing multiple members to communicate in a single thread. This is particularly useful for coordinating events, discussing common interests, or staying connected with a circle of friends or colleagues.

Additionally, the notification system 910 keeps users informed about activities related to their profile, such as new follows, comments, or likes. The notification system 910 keeps members informed and engaged with the platform's activities. This notification system 910 functions by sending alerts to members about various interactions and updates related to their profile or content they are interested in. Notifications are triggered by a range of activities, such as when another member likes or comments on their posts, follows their profile, tags them in a photo, or mentions them in a comment. In an embodiment, notifications include alerts about messages received, event reminders, or updates from groups or pages the member follows.

The functionality of notification system 910 is designed to be both informative and non-intrusive. Members can customize their notification settings, choosing what types of alerts they receive and how they are notified, whether through the platform's interface, email, or mobile push notifications. This customization enhances the member experience by allowing members to stay connected with the aspects of the platform they find most relevant, without being overwhelmed by excessive or irrelevant alerts.

In an embodiment, the notification system 910 incorporates smart algorithms to prioritize and sometimes group notifications based on the member's past interactions and preferences. For instance, a member might receive a summarized notification of all the likes on a post instead of separate alerts for each like. This intelligent handling ensures that members are kept up to date with important interactions and events, helping to increase member engagement and encouraging them to interact more frequently with the platform.

For community building, the groups and events module 912 allows the creation and management of interest-based groups and event organization. The groups and events module 912 allows members to create, join, and interact within focused communities based on shared interests, causes, or activities. In an embodiment, these groups range from public, open to anyone, to private, where membership requires approval. Within a group, members post content, engage in discussions, share resources, and collaborate on projects or initiatives. Groups have their own set of rules and moderators to ensure a constructive and respectful environment. This feature is instrumental in connecting individuals with common interests and facilitating deeper, topic-centered interactions.

The events feature of the groups and events module 912 complements the groups features of module 912 by enabling members to create, share, and manage events. Members set up event pages, where they provide details such as date, time, location, and description. These pages become a hub for inviting attendees, sharing updates, and posting event-related content. The groups and events module 912 includes tools for RSVPs, allowing both organizers and attendees to track who is planning to attend. In an embodiment, events are public or private, and are linked to specific groups or open to the broader network. This feature is particularly valuable for organizing meetups, workshops, conferences, or social gatherings, providing a seamless way to coordinate and communicate with participants.

Together, the groups and events module 912 enhances the social aspect of the networking platform. It encourages members to engage in more meaningful, interest-based interactions and provides tools for organizing and participating in real-world events, thus bridging the gap between online connections and offline activities.

Lastly, the privacy and security settings module 914 is designed to empower members with control over their personal information and interactions on the platform. This privacy and security settings module 914 provides various settings and options that enable members to manage who can view their profile, content, and personal details, as well as who can contact them. Members adjust settings to make their profiles either more public or private, determining the visibility of posts, photos, and friend lists. In an embodiment, members choose to make their content visible to everyone, only to their friends, or to a custom list of specific individuals.

In addition to privacy controls, this privacy and security settings module 914, in an embodiment, includes security features aimed at protecting members' accounts from unauthorized access. In an embodiment, this encompasses options like two-factor authentication, where a member must provide two forms of identification before accessing their account, and alerts for login attempts from unfamiliar devices or locations. In an embodiment, members also report suspicious activity and block or report other members who are harassing or spamming them.

Furthermore, the privacy and security settings module 914 provides tools for members to manage how their data is collected and used by the platform. This includes settings for opting out of certain types of data collection or controlling how their information is used for advertising purposes. By offering these comprehensive privacy and security options, the privacy and security settings module 914 not only safeguards members' personal information and accounts but also enhances their trust and comfort in using the platform, ultimately contributing to a safer and more controlled online environment.

### Example Programmable Electronic Device

FIG. 10 illustrates an example of an example programmable electronic device that processes and manipulates data to perform the techniques disclosed herein for generating responses to queries using entity-specific generative artificial intelligence agents. Example programmable electronic device 1000 includes electronic components encompassing hardware or hardware and software including processor 1002, memory 1004, auxiliary memory 1006, input device 1008, output device 1010, mass data storage 1012, and network interface 1014, all connected to bus 1016. Network 1022 is connected to, but not a component of, example programmable electronic device 1000.

While only one of each type of component is depicted in FIG. 10 for the purpose of providing a clear example, multiple instances of any or all these electronic components, including possibly multiple different types of instances, are present in example programmable electronic device 1000 in other instances. For example, in an embodiment, multiple processors are connected to bus 1016 such as, for example, one or more Central Processing Units (CPUs) and one or more Graphics Processing Units (GPUs).

Accordingly, unless the context clearly indicates otherwise, reference with respect to FIG. 10 to a component of example programmable electronic device 1000 in the singular such as, for example, processor 1002, is not intended to exclude the plural where, in a particular instance of example programmable electronic device 1000, multiple instances of the electronic component are present. Further, some electronic components might not be present in a particular instance of example programmable electronic device 1000. For example, example programmable electronic device 1000 in a headless configuration such as, for example, when operating as a server racked in a data center, might not include, or be connected to, input device 1008 or output device 1010.

Processor 1002 is an electronic component that processes (e.g., executes, interprets, or otherwise processes) instructions 1018 including instructions 1020 for generating responses to queries using entity-specific generative artificial intelligence agents. In an embodiment, processor 1002 fetches, decodes, and executes instructions 1018 from memory 1004 and performs arithmetic and logic operations dictated by instructions 1018 and coordinates the activities of other electronic components of example programmable electronic device 1000 in accordance with instructions 1018. In an embodiment, processor 1002 is made using silicon wafers according to a manufacturing process (e.g., 14 nanometer (nm), 10 nm, 7 nm, 5 nm, or 3 nm). In an embodiment, processor 1002 is configured to understand and execute a set of commands referred to as an instruction set architecture (ISA) (e.g., x86, x86_64, or ARM).

In an embodiment, processor 1002 includes a cache used to store frequently accessed instructions 1018 to speed up processing. In an embodiment, processor 1002 has multiple layers of cache (L1, L2, L3) with varying speeds and sizes.

In an embodiment, processor 1002 is composed of multiple cores where each such core is a processor within processor 1002. The cores allow processor 1002 to process multiple instructions 1018 at once in a parallel processing manner.

In an embodiment, processor 1002 supports multi-threading where each core of processor 1002 handles multiple threads (multiple sequences of instructions) at once to further enhance parallel processing capabilities.

In an embodiment, processor 1002 is any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other type of CPU suitable for the particular implementation at hand.

While processor 1002 might be a CPU, processor 1002, in an embodiment, is any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; specialized hardware for machine learning workloads, especially those involving tensors (multi-dimensional arrays); a field-programmable gate array (FPGA) or other reconfigurable integrated circuit that is customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other type of processor suitable for the particular implementation at hand.

Memory 1004 is an electronic component that stores data and instructions 1018 that processor 1002 processes. In an embodiment, memory 1004 provides the space for the operating system, applications, and data in current use to be quickly reached by processor 1002. In an embodiment, memory 1004 is a random-access memory (RAM) that allows data items to be read or written in substantially the same amount of time irrespective of the physical location of the data items inside memory 1004.

In an embodiment, memory 1004 is a volatile or non-volatile memory. Data stored in a volatile memory is lost when the power is turned off. Data in non-volatile memory remains intact even when the system is turned off. In an embodiment, memory 1004 is Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. In an embodiment, memory 1004 is Static RAM (SRAM). SRAM is volatile memory that is typically faster but more expensive than DRAM. SRAM uses multiple transistors for each memory cell but does not need to be periodically refreshed. Additionally, or alternatively, SRAM is used for cache memory in processor 1002 in an embodiment. In an embodiment, memory 1004 encompasses both DRAM and SRAM.

Example programmable electronic device 1000 has auxiliary memory 1006 other than memory 1004. Examples of auxiliary memory 1006 include cache memory, register memory, read-only memory (ROM), secondary storage, virtual memory, memory controller, and graphics memory. In an embodiment, example programmable electronic device 1000 has multiple auxiliary memories including different types of auxiliary memories.

Cache memory is found inside or very close to processor 1002 and is typically faster but smaller than memory 1004. Cache memory is used to hold frequently accessed instructions 1018 (encompassing any associated data) to speed up processing. In an embodiment, cache memory is hierarchical ranging from Level 1 cache memory which is the smallest but fastest cache memory and is typically inside processor 1002 to Level 2 and Level 3 cache memory which are progressively larger and slower cache memories that are inside or outside processor 1002.

Register memory is a small but very fast storage location within processor 1002 designed to hold data temporarily for ongoing operations.

ROM is a non-volatile memory device that is only read, not written to. In an embodiment, ROM is a Programmable ROM (PROM), Erasable PROM (EPROM), or electrically erasable PROM (EEPROM). In an embodiment, ROM stores basic input/output system (BIOS) instructions which help example programmable electronic device 1000 boot up.

Secondary storage is a non-volatile memory. In an embodiment, secondary storage encompasses any or all of: a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device.

Virtual memory is a portion of a hard drive or an SSD that the operating system uses as if it were memory 1004. When memory 1004 gets filled, less frequently accessed data and instructions 1018 is “swapped” out to the virtual memory. The virtual memory is slower than memory 1004, but it provides the illusion of having a larger memory 1004.

A memory controller manages the flow of data and instructions 1018 to and from memory 1004. The memory controller is located either on the motherboard of example programmable electronic device 1000 or within processor 1002.

Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 1008 is an electronic component that allows users to feed data and control signals into example programmable electronic device 1000. Input device 1008 translates a user's action or the data from the external world into a form that example programmable electronic device 1000 processes. Examples of input device 1008 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1010 is an electronic component that conveys information from example programmable electronic device 1000 to the user or to another device. The information is in the form of text, graphics, audio, video, or other media representation. Examples of output device 1010 include a monitor or display device, a printer device, a speaker device, a headphone device, a projector device, a plotter device, a braille display device, a haptic device, a LED or LCD panel device, a sound card, and a graphics or video card.

Mass data storage 1012 is an electronic component used to store data and instructions 1018. In an embodiment, mass data storage 1012 is non-volatile memory. Examples of mass data storage 1012 include a hard disk drive (HDD), a solid-state drive (SDD), an optical drive, a flash memory device, a magnetic tape drive, a floppy disk, an external drive, or a RAID array device.

In an embodiment, mass data storage 1012 is additionally or alternatively connected to example programmable electronic device 1000 via network 1022. In an embodiment, mass data storage 1012 encompasses a network attached storage (NAS) device, a storage area network (SAN) device, a cloud storage device, or a centralized network filesystem device.

Network interface 1014 (sometimes referred to as a network interface card, NIC, network adapter, or network interface controller) is an electronic component that connects example programmable electronic device 1000 to network 1022. Network interface 1014 functions to facilitate communication between example programmable electronic device 1000 and network 1022. Examples of a network interface 1014 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1016 is an electronic component that transfers data between other electronic components of or connected to example programmable electronic device 1000. Bus 1016 serves as a shared highway of communication for data and instructions (e.g., instructions 1018), providing a pathway for the exchange of information between components within example programmable electronic device 1000 or between example programmable electronic device 1000 and another device. Bus 1016 connects the different parts of example programmable electronic device 1000 to each other. In an embodiment, bus 1016 encompasses one or more of: a system bus, a front-side bus, a data bus, an address bus, a control bus, an expansion bus, a universal serial bus (USB), a I/O bus, a memory bus, an internal bus, an external bus, and a network bus.

Instructions 1018 are computer-processable instructions that take different forms. In an embodiment, instructions 1018 are in a low-level form such as binary instructions, assembly language, or machine code according to an instruction set (e.g., x86, ARM, MIPS) that processor 1002 is designed to process. In an embodiment, instructions 1018 include individual operations that processor 1002 is designed to perform such as arithmetic operations (e.g., add, subtract, multiply, divide, etc.); logical operations (e.g., AND, OR, NOT, XOR, etc.); data transfer operations including moving data from one location to another such as from memory 1004 into a register of processor 1002 or from a register to memory 1004; control instructions such as jumps, branches, calls, and returns; comparison operations; and specialization operations such as handling interrupts, floating-point arithmetic, and vector and matrix operations. In an embodiment, instructions 1018 are in a higher-level form such as programming language instructions in a high-level programming language such as Python, Java, C++, etc. In an embodiment, instructions 1018 are in an intermediate level form in between a higher-level form and a low-level form such as bytecode or an abstract syntax tree (AST).

Instructions 1018 for processing by processor 1002 are in different forms at the same or different times. In an embodiment, when stored in mass data storage 1012 or memory 1004, instructions 1018 are stored in a higher-level form such as Python, Java, or other high-level programing language instructions, in an intermediate-level form such as Python or Java bytecode that is compiled from the programming language instructions, or in a low-level form such as binary code or machine code. In an embodiment, when stored in processor 1002, instructions 1018 are stored in a low-level form such as binary instructions, assembly language, or machine code according to an instruction set architecture (ISA). In an embodiment, instructions 1018 are stored in processor 1002 in an intermediate level form or even a high-level form where CPU 1002 processes instructions in such form.

Instructions 1018 are processed by one or more processors of example programmable electronic device 1000 using a processing model such as any or all of the following processing models: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other processing model suitable to meet the requirements of the particular implementation at hand.

Network 1022 is a collection of interconnected computers, servers, and other programmable electronic devices that allow for the sharing of resources and information. Network 1022 ranges in size from just two connected devices to a global network (e.g., the internet) with many interconnected devices. In an embodiment, network 1022 encompasses network devices such as routers, switches, hubs, modems, and access points.

Individual devices on network 1022 are sometimes referred to as “network nodes.” Network nodes communicate with each other through mediums or channels sometimes referred to as “network communication links.” The network communication links are wired (e.g., twisted-pair cables, coaxial cables, or fiber-optic cables) or wireless (e.g., Wi-Fi, radio waves, or satellite links). Network nodes follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol).

Network 1022 has a particular physical or logical layout or arrangement sometimes referred to as a “network topology.” Example network topologies include bus, star, ring, and mesh. In an embodiment, network 1022 encompasses any or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

### Terminology

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses all of (a) a single processor configured to carry out recitations A, B, and C; (b) multiple processors where each processor is configured to carry out recitations A, B, and C; and (c) a first processor configured to carry out recitation A working in conjunction (e.g., as a team) with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses all of: (a) a single server configured to carry out recitations A, B, and C; (b) multiple servers each configured to carry out recitations A, B, and C; and (c) a first server configured to carry out recitations A and B working in conjunction (e.g., as a team) with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. is either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

### Privacy

In an embodiment, the techniques described herein are implemented with privacy safeguards to protect user privacy. Furthermore, in an embodiment, the techniques described herein are implemented with user privacy safeguards to prevent unauthorized access to personal data and confidential data. The training of the artificial intelligence (“AI”) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, in an embodiment, users have full control over the visibility of their content and who sees their content, as is controlled via the visibility settings. According to the techniques described herein, in an embodiment, users have full control over the level of their personal data that is shared and distributed between different AI platforms that provide different functionalities. According to the techniques described herein, in an embodiment, users have full control over the level of access to their personal data that is shared with other parties. According to the techniques described herein, personal data provided by users is, in an embodiment, processed to determine prompts when using a generative AI feature at the request of the user, but not to train generative AI models. In an embodiment, users provide feedback while using the techniques described herein, which are used to improve or modify the platform and products. In an embodiment, any personal data associated with a user, such as personal information provided by the user to the platform, is deleted from storage upon user request. In an embodiment, personal information associated with a user is permanently deleted from storage when a user deletes their account from the platform.

According to the techniques described herein, personal data is, in an embodiment, removed from any training dataset that is used to train AI models. The techniques described herein, in an embodiment, utilize tools for anonymizing member and customer data. For example, user's personal data is, in an embodiment, redacted and minimized in training datasets for training AI models through delexicalization tools and other privacy enhancing tools for safeguarding user data. The techniques described herein, in an embodiment, minimize use of any personal data in training AI models, including removing and replacing personal data. According to the techniques described herein, notices are, in an embodiment, communicated to users to inform how their data is being used and users are provided controls to opt-out from their data being used for training AI models.

According to some embodiments, tools are used with the techniques described herein to identify and mitigate risks associated with AI in all products and AI systems. In an embodiment, notices are provided to users when AI tools are being used to provide features.

What is claimed is:

1. A computer-implemented method comprising:
receiving a selection of a particular generative artificial intelligence (AI) agent, the selection from among a set of one or more AI agents, the particular generative artificial intelligence (AI) agent associated with an entity;
receiving a query, the query sent by a client device;
generating an embedding based on the query;
using the embedding to retrieve query-relevant content associated with the entity from a knowledge database that stores content associated with the entity;
determining a communication type associated with the entity;
generating a large language model (LLM) prompt comprising the query relevant content and instructions to apply the communication type to LLM output;
receiving a particular LLM output from a LLM service in response to submitting the LLM prompt to the LLM service; and
returning a response to the query based on the particular LLM output.

2. The computer-implemented method of claim 1, wherein the selection of the particular generative AI agent is based on one or more of:
(a) analyzing the query to determine a domain or subject matter associated with the query, and selecting the particular generative AI agent based on the domain or subject matter;
(b) analyzing the query to determine an intent or purpose associated with the query, and selecting the particular generative AI agent based on the intent or purpose;
(c) analyzing user data associated with the client device to determine user preferences or characteristics, and selecting the particular generative AI agent based on the user preferences or characteristics; or
(d) analyzing system data associated with the multi-user application system to determine system constraints or requirements, and selecting the particular generative AI agent based on the system constraints or requirements.

3. The computer-implemented method of claim 1, wherein the selection of the particular generative AI agent is made by a user of the client device based on one or more of:
(a) receiving a user input specifying the particular generative AI agent from a list of available generative AI agents presented to the user in a graphical user interface (GUI) at the client device;
(b) receiving a user input specifying criteria for selecting the particular generative AI agent, such as a desired domain, subject matter, or communication style, and a subsequent selection of the particular generative AI agent by the multi-user application system based on the user-specified criteria;
(c) accessing, by the multi-user application system, a user profile associated with the user and stored on the client device or the multi-user application system, the user profile indicating a preferred generative AI agent or preferences for selecting generative AI agents; or
(d) processing a user interaction history associated with the user and stored on the client device or the multi-user application system, the user interaction history indicating previous selections or preferences for generative AI agents by the user.

4. The method of claim 1, wherein generating the embedding based on the query in comprises:
retrieving a conversation history associated with the client device or the user of the client device, the conversation history comprising one or more previous queries and corresponding responses between the user and the generative AI agent;
augmenting the query with the retrieved conversation history to generate an augmented query, wherein the augmented query includes the query and relevant portions of the conversation history; and
generating the embedding based on the augmented query using the embedding generator, wherein the embedding represents a semantic understanding of the query in the context of the conversation history.

5. The method of claim 1, wherein generating the embedding based on the query in comprises:
analyzing the query using a query rewriting module to identify one or more of:
spelling or grammatical errors in the query;
ambiguous or unclear terms in the query;
irrelevant or unnecessary information in the query; or
complex or compound questions in the query;
rewriting the query based on the analysis to generate a rewritten query, wherein the rewritten query corrects spelling or grammatical errors, clarifies ambiguous terms, removes irrelevant information, or simplifies complex questions; and
generating the embedding based on the rewritten query using the embedding generator, wherein the embedding represents a semantic understanding of the rewritten query.

6. The method of claim 1, wherein the communication type associated with the entity indicates a conversational tone or style of the entity, and wherein the conversational tone or style comprises one or more of:
a formal or informal tone;
a friendly or professional tone;
a humorous or serious tone;
a concise or elaborate style;
a direct or indirect style;
an empathetic or neutral tone; or
a persuasive or informative tone.

7. The method of claim 1, wherein generating the LLM prompt comprises:
analyzing the communication type associated with the entity to identify one or more communication attributes, wherein the communication attributes specify characteristics of the entity's communication style;
generating instructions based on the identified communication attributes, wherein the instructions guide the LLM service to generate the particular LLM output in accordance with the entity's communication style; and
constructing the LLM prompt to comprise:
the query or a rewritten or augmented version of the query;
the query-relevant content retrieved from the knowledge database; and
the generated instructions for applying the communication type to LLM output to generate the particular LLM output in accordance with the entity's communication style.

8. The method of claim 1, further comprising:
prior to generating the embedding based on the query:
analyzing the query using an on-topic classifier module to determine whether the query (104) is on-topic or off-topic for the particular generative AI agent;
if the query is determined to be off-topic:
identifying one or more key entities, concepts, or themes from the query that are relevant to the generative AI agent's knowledge domain;
reformulating the query by modifying, expanding, or narrowing its scope based on the identified key entities, concepts, or themes to generate a reformulated query that is on-topic for the generative AI agent;
replacing the original query with the reformulated query for subsequent processing steps; and
generating the embedding based on the reformulated on-topic query, wherein the embedding represents a semantic understanding of the reformulated query.

9. A system comprising:
a set of one or more non-transitory computer-readable media storing a set of computer-processable instructions; and
a set of one or more processors operable to process the set of computer-processable instructions, wherein the set of computer-processable instructions are configured to perform:
receiving a selection of a particular generative artificial intelligence (AI) agent, the selection from among a set of one or more AI agents, the particular generative artificial intelligence (AI) agent associated with an entity;
receiving a query, the query sent by a client device;
generating an embedding based on the query;
using the embedding to retrieve query-relevant content associated with the entity from a knowledge database that stores content associated with the entity;
determining a communication type associated with the entity;
generating a large language model (LLM) prompt comprising the query relevant content and instructions to apply the communication type to LLM output;
receiving a particular LLM output from a LLM service in response to submitting the LLM prompt to the LLM service; and
returning a response to the query based on the particular LLM output.

10. The system of claim 9, wherein the set of computer-processable instructions further comprises computer-processable instructions to perform:
(a) analyzing the query to determine a domain or subject matter associated with the query, and selecting the particular generative AI agent based on the domain or subject matter;
(b) analyzing the query to determine an intent or purpose associated with the query, and selecting the particular generative AI agent based on the intent or purpose;
(c) analyzing user data associated with the client device to determine user preferences or characteristics, and selecting the particular generative AI agent based on the user preferences or characteristics; or
(d) analyzing system data associated with the multi-user application system to determine system constraints or requirements, and selecting the particular generative AI agent based on the system constraints or requirements.

11. The system of claim 9, wherein the set of computer-processable instructions further comprises computer-processable instructions to perform:
(a) receiving a user input specifying the particular generative AI agent from a list of available generative AI agents presented to the user in a graphical user interface (GUI) at the client device;
(b) receiving a user input specifying criteria for selecting the particular generative AI agent, such as a desired domain, subject matter, or communication style, and a subsequent selection of the particular generative AI agent by the multi-user application system based on the user-specified criteria;
(c) accessing a user profile associated with the user and stored on the client device or the multi-user application system, the user profile indicating a preferred generative AI agent or preferences for selecting generative AI agents; or
(d) processing, by the multi-user application system, a user interaction history associated with the user and stored on the client device or the multi-user application system, the user interaction history indicating previous selections or preferences for generative AI agents by the user.

12. The system of claim 9, wherein the set of computer-processable instructions further comprises computer-processable instructions to perform:
analyzing the query using a query rewriting module to identify one or more of:
spelling or grammatical errors in the query;
ambiguous or unclear terms in the query;
irrelevant or unnecessary information in the query; or
complex or compound questions in the query;
rewriting the query based on the analysis to generate a rewritten query, wherein the rewritten query corrects spelling or grammatical errors, clarifies ambiguous terms, removes irrelevant information, or simplifies complex questions; and
generating the embedding based on the rewritten query using the embedding generator, wherein the embedding represents a semantic understanding of the rewritten query.

13. The system of claim 9, wherein the communication type associated with the entity indicates a conversational tone or style of the entity, and wherein the conversational tone or style comprises one or more of:
a formal or informal tone;
a friendly or professional tone;
a humorous or serious tone;
a concise or elaborate style;
a direct or indirect style;
an empathetic or neutral tone; or
a persuasive or informative tone.

14. The system of claim 9, wherein the set of computer-processable instructions further comprises computer-processable instructions to perform:
analyzing the communication type associated with the entity to identify one or more communication attributes, wherein the communication attributes specify characteristics of the entity's communication style;
generating instructions based on the identified communication attributes, wherein the instructions guide the LLM service to generate the particular LLM output in accordance with the entity's communication style; and
constructing the LLM prompt to comprise:
the query or a rewritten or augmented version of the query;
the query-relevant content retrieved from the knowledge database; and
the generated instructions for applying the communication type to LLM output to generate the particular LLM output in accordance with the entity's communication style.

15. The system of claim 9, wherein the set of computer-processable instructions further comprises computer-processable instructions to perform:
prior to generating the embedding based on the query:
analyzing the query using an on-topic classifier module to determine whether the query is on-topic or off-topic for the particular generative AI agent;
if the query is determined to be off-topic:
identifying one or more key entities, concepts, or themes from the query that are relevant to the generative AI agent's knowledge domain;
reformulating the query by modifying, expanding, or narrowing its scope based on the identified key entities, concepts, or themes to generate a reformulated query that is on-topic for the generative AI agent;
replacing the original query with the reformulated query for subsequent processing steps; and
generating the embedding based on the reformulated on-topic query, wherein the embedding represents a semantic understanding of the reformulated query.

16. A set of one or more non-transitory computer-readable media storing a set of computer-processable instructions which, when processed, cause a set of one or more processors operable to process the set of computer-processable instructions, wherein the set of computer-processable instructions comprise computer-processable instructions to:
receiving a selection of a particular generative artificial intelligence (AI) agent, the selection from among a set of one or more AI agents, the particular generative artificial intelligence (AI) agent associated with an entity;
wherein the selection of the particular generative AI agent is made by a user of the client device based on receiving a user input specifying the particular generative AI agent from a list of available generative AI agents presented to the user in a graphical user interface (GUI) at the client device;
receiving a query, the query sent by a client device;
generating an embedding based on the query;
using the embedding to retrieve query-relevant content associated with the entity from a knowledge database that stores content associated with the entity;
determining a communication type associated with the entity;
generating a large language model (LLM) prompt comprising the query relevant content and instructions to apply the communication type to LLM output;
receiving a particular LLM output from a LLM service in response to submitting the LLM prompt to the LLM service; and
returning a response to the query based on the particular LLM output.

17. The set of one or more non-transitory computer-readable media of claim 16, further storing a set of computer-processable instructions configured to perform:
analyzing the query using a query rewriting module to identify one or more of:
spelling or grammatical errors in the query;
ambiguous or unclear terms in the query;
irrelevant or unnecessary information in the query; or
complex or compound questions in the query;
rewriting the query based on the analysis to generate a rewritten query, wherein the rewritten query corrects spelling or grammatical errors, clarifies ambiguous terms, removes irrelevant information, or simplifies complex questions; and
generating the embedding based on the rewritten query using the embedding generator, wherein the embedding represents a semantic understanding of the rewritten query.

18. The set of one or more non-transitory computer-readable media of claim 16, wherein the communication type associated with the entity indicates a conversational tone or style of the entity, and wherein the conversational tone or style comprises one or more of:
a formal or informal tone;
a friendly or professional tone;
a humorous or serious tone;
a concise or elaborate style;
a direct or indirect style;
an empathetic or neutral tone; or
a persuasive or informative tone.

19. The set of one or more non-transitory computer-readable media of claim 11, further storing a set of computer-processable instructions configured to perform:
analyzing the communication type associated with the entity to identify one or more communication attributes, wherein the communication attributes specify characteristics of the entity's communication style;
generating instructions based on the identified communication attributes, wherein the instructions guide the LLM service to generate the particular LLM output in accordance with the entity's communication style; and
constructing the LLM prompt to comprise:
the query or a rewritten or augmented version of the query;
the query-relevant content retrieved from the knowledge database; and
the generated instructions for applying the communication type to LLM output to generate the particular LLM output in accordance with the entity's communication style.

20. The set of one or more non-transitory computer-readable media of claim 11, further storing a set of computer-processable instructions configured to perform:
prior to generating the embedding based on the query:
analyzing the query using an on-topic classifier module to determine whether the query is on-topic or off-topic for the particular generative AI agent;
if the query is determined to be off-topic:
identifying one or more key entities, concepts, or themes from the query that are relevant to the generative AI agent's knowledge domain;
reformulating the query by modifying, expanding, or narrowing its scope based on the identified key entities, concepts, or themes to generate a reformulated query that is on-topic for the generative AI agent;
replacing the original query with the reformulated query for subsequent processing steps; and
generating the embedding based on the reformulated on-topic query, wherein the embedding represents a semantic understanding of the reformulated query.
